(19) United States
(12) Patent Application Publication
(10) Pub. No.: US 2020/0024207 A1
(43) Pub. Date: Jan. 23, 2020

(54) METHOD OF PROMOTING BACILLUS SPORE GERMINATION

(71) Applicant: Bayer CropScience LP, St. Louis, MO (US)

(72) Inventors: Albert SCHIRRING, Ratingen (DE); Varghese P. THOMAS, Davis, CA (US); Angelynn Fung-Ling CHOW, Sacramento, CA (US)

(21) Appl. No.: 16/480,492

(22) PCT Filed: Jan. 25, 2018
(86) PCT No.: PCT/US2018/015125

§ 371 Date: Jul. 24, 2019

Related U.S. Application Data
(60) Provisional application No. 62/450,735, filed on Jan. 26, 2017.

(51) Int. Cl. C05F 11/08; C12R 1/125; C05B 1/04

(52) U.S. Cl. CPC C05F 11/08; C05B 1/04; C12R 1/125

(57) ABSTRACT

The present invention provides a method of promoting spore germination and/or vegetative growth of a plant growth-promoting Bacillus or Paenibacillus isolate, the method comprising simultaneously or sequentially applying inorganic phosphate and the plant growth-promoting Bacillus or Paenibacillus isolate to a plant, a plant part, a plant propagule, a seed of a plant and/or a locus

### CROSS REFERENCE TO RELATED APPLICATIONS

This application claims priority to U.S. Provisional Patent Application No. 62/450,735, filed January 26, 2017, the contents of which is incorporated herein by reference in its entirety.

### TECHNICAL FIELD

The present invention relates to the field of plant growth-promoting rhizobacteria and, specifically, to methods of promoting spore germination and/or vegetative growth of a Bacillus isolate by applying inorganic phosphate with the Bacillus isolate.

### BACKGROUND

In response to environmental factors, certain microorganisms, such as various Bacillus species, will form endospores. A spore is a rigid structure with no detectable metabolic activity. The general spore structure includes an outer exosporium, a spore coat, a spore cortex, an inner membrane and finally a spore core cell. Endospores are significantly more resistant to environmental fluctuations in pH, temperature, humidity and radiation than are vegetative cells. Although microbial spores will remain dormant for extended periods of time, spores contain mechanisms that trigger germination under certain circumstances. The germination process consists of a series of degradative steps that break down the spore coat and spore cortex allowing water and nutrients to enter the spore core cell. Following germination, metabolic activity is reactivated and outgrowth of a new vegetative cell occurs. Germination and subsequent outgrowth are distinct but related processes. That is, even though a spore germinates it might not complete the outgrowth process. Outgrowth of a new vegetative cell, however, cannot occur unless the spore germinates. The mechanisms that trigger spore germination are not fully understood.

There is growing interest in the use of Bacillus species as possible alternatives or supplements to fertilizer for advancing plant growth. Various Bacillus cells can colonize plant roots and the rhizosphere where they exert a beneficial effect on the plant. Exudation by plant roots, bacterial colonization in the roots, and soil health each impact the ability of Bacillus cells to improve plant growth and crop yield. See Souza et al., Genetics and Molecular Biology [2015] 38, 4, 401-419. The mechanism behind the effect of plant-associated bacteria on plant growth is still open to speculation. Ryu et al., (Proc. Natl. Acad. Sci. U.S.A. [2003] 100, 4927-4932) have suggested that among rhizobacteria which colonize roots some strains regulate plant growth by releasing 2,3-butanediol and/or acetoin.

Bacillus-based agricultural products are generally formulated as mixtures or suspensions of endospores to improve stability and shelf-life (see, e.g., U.S Pat. No. 5,215,747 and Herrmann, L., et al., (2013) Applied Microbiology and Biotechnology 97(20): 8859-8873). The endospores must germinate and produce vegetative cells to exert a beneficial effect on plant growth. However, the mechanisms and chemical signals promoting bacterial spore germination and vegetative growth are not well understood. Thus, there is a need for methods to promote endospore germination and vegetative cell growth of Bacillus-based agricultural products after application.

### SUMMARY

The present invention relates to a method of promoting spore germination and/or vegetative growth of a plant growth-promoting Bacillus or Paenibacillus isolate, the method comprising simultaneously or sequentially applying inorganic phosphate and the plant growth-promoting Bacillus or Paenibacillus isolate to a plant, a plant part, a plant propagule, a seed of a plant and/or a locus where a plant is growing or is intended to grow.

In certain aspects, the plant growth-promoting Bacillus or Paenibacillus isolate and the inorganic phosphate are applied before planting, at planting and/or post-planting. In other aspects, the plant growth-promoting Bacillus or Paenibacillus isolate and the inorganic phosphate are applied to a seed, plant propagule, plant root and/or rhizosphere.

In one aspect, the plant growth-promoting Bacillus or Paenibacillus isolate and the inorganic phosphate are applied as a soil surface drench, shanked-in, injected, applied in-furrow, as a band application along the seeding/planting line and/or applied by mixture with irrigation water.

In yet another aspect, the plant growth-promoting Bacillus isolate is Bacillus subtilis, Bacillus amyloliquefaciens, Bacillus pumilus, or a combination thereof. In some aspects, the plant growth-promoting Bacillus isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof. In one embodiment, the plant growth-promoting Bacillus isolate is Bacillus subtilis strain QST713 (Accession No. NRRL B-21661).

In certain aspects, the plant growth-promoting Paenibacillus isolate is Paenibacillus alvei, Paenibacillus amylolyticus, Paenibacillus macerans, Paenibacillus polymyxa, Paenibacillus popilliae, Paenibacillus terrae, or a combination thereof. In one aspect, the plant growth-promoting Paenibacillus isolate is selected from the group consisting of Paenibacillus alvei strain T36, Paenibacillus alvei strain III3DT-1A, Paenibacillus alvei strain 1112E, Paenibacillus alvei strain 46C3, Paenibacillus alvei strain 2771, Paenibacillus polymyxa strain AC-1, Paenibacillus sp. strain NRRL B-50972, Paenibacillus sp. strain NRRL B-67129, mutants thereof with all the identifying characteristics of the respective strain, and combinations thereof. In a particular aspect, the plant growth-promoting Paenibacillus isolate is Paenibacillus sp. strain NRRL B-67129 or a mutant thereof with all the identifying characteristics of the strain.

In other aspects, the inorganic phosphate comprises phosphoric acid, polyphosphoric acid, phosphorous acid and/or a salt of H₂PO₄⁻, H₂PO₃⁻, HPO₄²⁻ or PO₄³⁻. In a certain embodiment, the inorganic phosphate is selected from the group consisting of monoammonium phosphate, diammonium phosphate, monopotassium phosphate, dipotassium phosphate, ammonium polyphosphate, calcium phosphate, magnesium phosphate, zinc phosphate, manganese phosphate, iron phosphate, potassium phosphite, copper phosphate, and combinations thereof. In another embodiment, the inorganic phosphate comprises an NPK fertilizer or rock phosphate.

In one aspect, the inorganic phosphate is monopotassium phosphate. In some embodiments, the concentration of monopotassium phosphate on the plant, plant part, plant propagule, seed of the plant and/or the locus where the plant is growing is between about 0.1 mM and about 100 mM.

In another embodiment, the inorganic phosphate is calcium phosphate, monobasic (Ca(H₂PO₄)₂), calcium phosphate, dibasic (CaHPO₄), or a combination thereof.

In one aspect, the concentration of inorganic phosphate (e.g., calcium phosphate) on the plant, plant part, plant propagule, seed of the plant and/or the locus where the plant is growing is between about 0.2mg/mL and about 2.7 mg/mL.

In yet another embodiment, the inorganic phosphate is ammonium polyphosphate.

In certain aspects, the plant is a monocot or a dicot. In one embodiment, the monocot is selected from the group consisting of corn, wheat, oat, rice, sorghum, sugar cane, milo, buckwheat, rye, grass, and barley. In another embodiment, the dicot is selected from the group consisting of alfalfa, apple, apricot, asparagus, banana, bean, berry, blackberry, blueberry, broccoli, canola, carrot, cassava, cauliflower, celery, cherry, chickpea, citrus tree, cotton, cowpea, cranberry, cucumber, cucurbit, eggplant, fruit tree, grape, leek, lemon, lettuce, linseed, melon, mustard, nut bearing tree, oil palm, okra, onion, orange, pea, peach, peanut, pear, plum, potato, spinach, soybeans, squash, strawberry, sugar beet, sunflower, sweet potato, tobacco, tomato, turnip, and vegetable.

The present invention also relates to the use of an inorganic phosphate for promoting spore germination and/or vegetative growth of a plant growth-promoting Bacillus or Paenibacillus isolate.

In other embodiments, the present invention is directed to a kit of parts comprising: a plant growth-promoting Bacillus or Paenibacillus isolate; and an inorganic phosphate selected from the group consisting of phosphoric acid, polyphosphoric acid, phosphorous acid and a salt of H₂PO₄₋, H₂PO₃⁻, HPO₄²⁻ or PO₄³⁻. The inorganic phosphate may be any one of monoammonium phosphate, diammonium phosphate, monopotassium phosphate, dipotassium phosphate, ammonium polyphosphate, calcium phosphate, magnesium phosphate, zinc phosphate, manganese phosphate, iron phosphate, potassium phosphite, copper phosphate, and combinations thereof. In one aspect, the inorganic phosphate comprises an NPK fertilizer or rock phosphate. In another aspect, the inorganic phosphate is monopotassium phosphate, calcium phosphate, or ammonium polyphosphate. In one embodiment, the inorganic phosphate is monopotassium phosphate. In another embodiment, the inorganic phosphate is calcium phosphate. In yet another embodiment, the inorganic phosphate is ammonium polyphosphate.

In another aspect, the plant growth-promoting Bacillus isolate in the kit of parts is Bacillus subtilis, Bacillus amyloliquefaciens, Bacillus pumilus, or a combination thereof. The plant growth-promoting Bacillus isolate may be any one of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof.

### BRIEF DESCRIPTION OF THE DRAWINGS

FIG. 1 depicts metabolic activity of B. subtilis QST713 bacterial spores cultured in monopotassium phosphate in minimal medium without growth nutrients.

FIG. 2 depicts metabolic activity of B. subtilis QST713 bacterial spores cultured in monopotassium phosphate supplemented with TSB-Schaeffer's Medium.

FIG. 3 depicts metabolic activity of B. subtilis QST713 bacterial spores cultured in monopotassium phosphate supplemented with root exudate collected from a corn variety (i.e., corn root exudate #1).

FIG. 4 depicts metabolic activity of B. subtilis QST713 bacterial spores cultured in monopotassium phosphate supplemented with root exudate collected from a different corn variety (i.e., corn root exudate #2).

FIG. 5 depicts metabolic activity of B. subtilis MBI 600 bacterial spores cultured in monopotassium phosphate supplemented with TSB-Schaeffer's Medium.

FIG. 6 depicts metabolic activity of B. subtilis GBO₃ bacterial spores cultured in monopotassium phosphate supplemented with TSB-Schaeffer' s Medium.

FIG. 7 depicts metabolic activity of B. pumilus QST2808 bacterial spores cultured in monopotassium phosphate supplemented with TSB-Schaeffer's Medium.

FIG. 8 depicts metabolic activity of B. amyloliquefaciens FZB42 bacterial spores cultured in monopotassium phosphate supplemented with TSB-Schaeffer's Medium.

FIG. 9 depicts metabolic activity of B. subtilis QST713 bacterial spores cultured in Triple Super Phosphate in minimal medium without growth nutrients.

FIG. 10 depicts metabolic activity of B. subtilis QST713 bacterial spores cultured in 0.3 mg/mL, 0.03 mg/mL, or 0.003 mg/mL Triple Super Phosphate supplemented with TSB-Schaeffer's Medium compared to a control without Triple Super Phosphate.

FIG. 11 depicts metabolic activity of B. subtilis QST713 bacterial spores cultured in 2.0 mg/mL, 1.0 mg/mL, or 0.3 mg/mL Triple Super Phosphate supplemented with TSB-Schaeffer's Medium compared to a control without Triple Super Phosphate.

FIG. 12 depicts metabolic activity of B. subtilis QST713 bacterial spores cultured in 11.3 mg/mL, 5.6 mg/mL, or 2.8 mg/mL Triple Super Phosphate supplemented with TSB-Schaeffer's Medium compared to a control without Triple Super Phosphate.

FIG. 13 depicts metabolic activity of B. subtilis QST713 bacterial spores cultured in 1 mg/mL, 0.1 mg/mL, or 0.01 mg/mL Triple Super Phosphate supplemented with corn root exudate compared to a control without Triple Super Phosphate.

FIG. 14 depicts metabolic activity of B. subtilis QST713 bacterial spores cultured in 2.0 mg/mL, 1.0 mg/mL, or 0.3 mg/mL Triple Super Phosphate supplemented with corn root exudate compared to a control without Triple Super Phosphate.

FIG. 15 depicts metabolic activity of B. subtilis MBI 600 bacterial spores cultured in 2.0 mg/mL, 1.0 mg/mL, or 0.3 mg/mL Triple Super Phosphate supplemented with TSB-Schaeffer's Medium compared to a control without Triple Super Phosphate.

FIG. 16 depicts metabolic activity of B. subtilis GBO₃ bacterial spores cultured in 2.0 mg/mL, 1.0 mg/mL, or 0.3 mg/mL Triple Super Phosphate supplemented with TSB-Schaeffer's Medium compared to a control without Triple Super Phosphate.

FIG. 17 depicts metabolic activity of B. pumilus QST2808 bacterial spores cultured in 2.0 mg/mL, 1.0 mg/mL, or 0.3 mg/mL Triple Super Phosphate supplemented with TSB-Schaeffer's Medium compared to a control without Triple Super Phosphate.

FIG. 18 depicts metabolic activity of B. amyloliquefaciens FZB42 bacterial spores cultured in 2.0 mg/mL, 1.0 mg/mL, or 0.3 mg/mL Triple Super Phosphate supplemented with TSB-Schaeffer' s Medium compared to a control without Triple Super Phosphate.

FIG. 19 depicts metabolic activity of B. subtilis QST713 bacterial spores cultured in dilutions of 1:2, 1:4, 1:8, or 1:16 of 10-34-0 Liquid Ammonium Polyphosphate supplemented with TSB-Schaeffer' s Medium compared to a first control without 10-34-0 Liquid Ammonium Polyphosphate and a second control with 10-34-0 Liquid Ammonium Polyphosphate but without TSB-Schaeffer's Medium.

### DETAILED DESCRIPTION

As used herein, the verb “comprise” as is used in this description and in the claims and its conjugations are used in its non-limiting sense to mean that items following the word are included, but items not specifically mentioned are not excluded. In addition, reference to an element by the indefinite article “a” or “an” does not exclude the possibility that more than one of the elements are present, unless the context clearly requires that there is one and only one of the elements. The indefinite article “a” or “an” thus usually means “at least one”.

As used herein, the terms “spore” and “endospore” refer to a stress-resistant non-reproductive dormant cell structure that develops inside bacteria.

The term “mutant” refers to a genetic variant derived from a plant growth-promoting Bacillus or Paenibacillus isolate. In one embodiment, the mutant has all the identifying characteristics of the plant growth-promoting Bacillus or Paenibacillus isolate. In another embodiment, mutants are genetic variants having a genomic sequence that has greater than about 85%, greater than about 90%, greater than about 95%, greater than about 98%, or greater than about 99% sequence identity to the plant growth-promoting Bacillus or Paenibacillus isolate. Mutants may be obtained by treating plant growth-promoting Bacillus or Paenibacillus isolate cells with chemicals or irradiation or by selecting spontaneous mutants from a population of such cells (such as phage resistant mutants), or by other means well known to those practiced in the art. Targeted mutations may be introduced with CRISPR/Cas genome editing techniques.

In one embodiment, the present invention provides a method of promoting spore germination and/or vegetative growth of a plant growth-promoting Bacillus or Paenibacillus isolate, the method comprising simultaneously or sequentially applying inorganic phosphate and the plant growth-promoting Bacillus or Paenibacillus isolate to a plant, a plant part, a plant propagule, a seed of a plant and/or a locus where a plant is growing or is intended to grow, wherein the inorganic phosphate comprises phosphoric acid, polyphosphoric acid, phosphorous acid and/or a salt of H₂PO₄⁻, H₂PO₃⁻, HPO₄²⁻or PO₄³⁻.

In one aspect, the plant growth-promoting Bacillus isolate is Bacillus subtilis, Bacillus amyloliquefaciens, Bacillus pumilus, or a combination thereof. In another aspect, the plant growth-promoting Bacillus isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof.

In another embodiment, the inorganic phosphate is selected from the group consisting of monoammonium phosphate, diammonium phosphate, monopotassium phosphate, dipotassium phosphate, ammonium polyphosphate, calcium phosphate, magnesium phosphate, zinc phosphate, manganese phosphate, iron phosphate, potassium phosphite, copper phosphate, and combinations thereof.

In one embodiment, the inorganic phosphate is monopotassium phosphate. In certain aspects, the concentration of monopotassium phosphate on the plant, plant part, plant propagule, seed of the plant and/or the locus where the plant is growing is between about 0.1 mM and about 100 mM.

In another embodiment, the inorganic phosphate is calcium phosphate, monobasic (Ca(H₂PO₄)₂), calcium phosphate, dibasic (CaHPO₄), or a combination thereof. In one aspect, the concentration of inorganic phosphate on the plant, plant part, plant propagule, seed of the plant and/or the locus where the plant is growing is between about 0.2 mg/mL and about 2.7 mg/mL.

In yet another embodiment, the inorganic phosphate is ammonium polyphosphate.

In some aspects, the plant is selected from the group consisting of alfalfa, apple, apricot, asparagus, banana, bean, berry, blackberry, blueberry, broccoli, canola, carrot, cassava, cauliflower, celery, cherry, chickpea, citrus tree, cotton, cowpea, cranberry, cucumber, cucurbit, eggplant, fruit tree, grape, leek, lemon, lettuce, linseed, melon, mustard, nut bearing tree, oil palm, okra, onion, orange, pea, peach, peanut, pear, plum, potato, spinach, soybeans, squash, strawberry, sugar beet, sunflower, sweet potato, tobacco, tomato, turnip, and vegetable. In one embodiment, the plant is potato.

In yet another embodiment, the present invention provides use of an inorganic phosphate for promoting spore germination and/or vegetative growth of a plant growth-promoting Bacillus or Paenibacillus isolate, wherein the inorganic phosphate comprises phosphoric acid, polyphosphoric acid, phosphorous acid and/or a salt of H₂PO₄⁻, H₂PO₃⁻, HPO₄²⁻ or PO₄³⁻, and wherein the plant growth-promoting Bacillus isolate is Bacillus subtilis, Bacillus amyloliquefaciens, Bacillus pumilus, or a combination thereof.

In certain aspects, the plant growth-promoting microbial isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof.

In one embodiment, the present invention relates to a kit of parts comprising: a plant growth-promoting Bacillus or Paenibacillus isolate; and an inorganic phosphate selected from the group consisting of phosphoric acid, polyphosphoric acid, phosphorous acid and a salt of H₂PO₄₋, H₂PO₃₋, HPO₄²⁻ or PO₄³⁻, wherein the plant growth-promoting Bacillus isolate is Bacillus subtilis, Bacillus amyloliquefaciens, Bacillus pumilus, or a combination thereof.

In one aspect, the inorganic phosphate is selected from the group consisting of monoammonium phosphate, diammonium phosphate, monopotassium phosphate, dipotassium phosphate, ammonium polyphosphate, calcium phosphate, magnesium phosphate, zinc phosphate, manganese phosphate, iron phosphate, potassium phosphite, copper phosphate, and combinations thereof.

In another aspect, the plant growth-promoting Bacillus isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof.

In certain aspects, the presence of the inorganic phosphate and the plant growth-promoting microbial isolate together on the plant roots and/or in the rhizosphere stimulates the plant roots to release organic acids to promote spore germination and/or vegetative growth. In other aspects, the organic acids are selected from the group consisting of alpha-ketoglutarate, citramalic acid, citric acid, gluconic acid, 2-hydroxybutanoic acid, 2-hydroxyglutaric acid, 2-isopropylmalic acid, isothreonic acid, 2-ketoisocaproic acid, lactic acid, succinic acid, and combinations thereof.

In certain aspects, the inorganic phosphate and the plant growth-promoting Bacillus or Paenibacillus isolate are applied to a plant, a plant part, such as a seed, root rhizome, corm, bulb, or tuber, and/or a locus on which the plant or the plant parts grow, such as soil. Application may be made by a seed/root/tuber/rhizome/bulb/corm treatment and/or as a soil treatment and/or treatment of artificial soil substrates (e.g., rockwool, perlite, glass, and coconut fiber). The seeds/root/tubers/rhizomes/bulbs/corms can be treated before planting, during planting or after planting.

In some embodiments, the present invention provides a method of promoting spore germination and/or vegetative growth of a plant growth-promoting Bacillus or Paenibacillus isolate, the method comprising simultaneously or sequentially applying inorganic phosphate and the plant growth-promoting Bacillus or Paenibacillus isolate to a plant, a plant part, a plant propagule, a seed of a plant and/or a locus where a plant is growing or is intended to grow.

In certain aspects, the concentration of the inorganic phosphate on the plant, plant part, plant propagule, seed of the plant and/or the locus where the plant is growing is between about 0.01 mM and about 1 M, between about 0.01 mM and about 500 mM, between about 0.01 mM and about 250 mM, between about 0.01 mM and about 100 mM, between about 0.01 mM and about 50 mM, between about 0.01 mM and about 30 mM, between about 0.1 mM and about 1 M, between about 0.1 mM and about 500 mM, between about 0.1 mM and about 250 mM, between about 0.1 mM and about 100 mM, between about 0.1 mM and about 50 mM, between about 0.1 mM and about 30 mM, between about 0.25 mM and about 1 M, between about 0.25 mM and about 500 mM, between about 0.25 mM and about 250 mM, between about 0.25 mM and about 100 mM, between about 0.25 mM and about 50 mM, or between about 0.25 mM and about 30 mM.

In certain aspects, the concentration of the inorganic phosphate on the plant, plant part, plant propagule, seed of the plant and/or the locus where the plant is growing is between about 0.05 mg/mL and about 20 mg/mL, between about 0.05 mg/mL and about 10 mg/mL, between about 0.05 mg/mL and about 5 mg/mL, between about 0.05 mg/mL and about 2.5 mg/mL, between about 0.1 mg/mL and about 20 mg/mL, between about 0.1 mg/mL and about 10 mg/mL, between about 0.1 mg/mL and about 5 mg/mL, between about 0.1 mg/mL and about 2.5 mg/mL, between about 0.2 mg/mL and about 20 mg/mL, between about 0.2 mg/mL and about 10 mg/mL, between about 0.2 mg/mL and about 5 mg/mL, between about 0.2 mg/mL and about 2.5 mg/mL, between about 0.3 mg/mL and about 20 mg/mL, between about 0.3 mg/mL and about 10 mg/mL, between about 0.3 mg/mL and about 5 mg/mL, between about 0.3 mg/mL and about 2.5 mg/mL, or between about 0.3 mg/mL and about 2 mg/mL.

The genus Bacillus as used herein refers to a genus of Gram-positive, rod-shaped bacteria which are members of the division Firmicutes. Bacillus bacteria may be characterized and identified based on the nucleotide sequence of their 16S rRNA or a fragment thereof (e.g., approximately a 1000 nt, 1100 nt, 1200 nt, 1300 nt, 1400 nt, or 1500 nt fragment of 16S rRNA or rDNA nucleotide sequence). The Bacillus isolate of the present invention may be any one of B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altit dinis, B. alveayuensis, B. amyloliquefaciens, B. anthracia, B. aquimaris, B. arsenicus, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyiicus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. faslidiosus, B. firmus, B. flexus, B. foraminis, B. fordii, B. fortis, B. fumarioli, B. funiculus, B. galactosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. krul chiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus, B. qingdaonensis, B. rigui, B. runs, B. safensis, B. salarius, B. saliphilus, B. schlegelii, B. selenatarsenatis, B. selenitireducens, B. seohaeanensis, B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. the rmoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and mixtures or blends thereof.

In some embodiments, the plant growth-promoting Bacillus isolate is Bacillus subtilis, Bacillus amyloliquefaciens, Bacillus pumilus, or a combination thereof.

In certain embodiments, the plant growth-promoting microbial isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), Paenibacillus sp. strain NRRL B-50972, Paenibacillus sp. strain NRRL B-67129, mutants thereof with all the identifying characteristics of the respective strain, and combinations thereof.

In other embodiments, the present invention provides a method of promoting spore germination and/or vegetative growth of a plant growth-promoting Paenibacillus isolate, the method comprising simultaneously or sequentially applying inorganic phosphate and the plant growth-promoting Paenibacillus isolate to a plant, a plant part, a plant propagule, a seed of a plant and/or a locus where a plant is growing or is intended to grow.

The Paenibacillus isolate of the present invention may be any one of Paenibacillus abyssi, Paenibacillus aceti, Paenibacillus aestuarii, Paenibacillus agarexedens, Paenibacillus agaridevorans, Paenibacillus alginolyticus, Paenibacillus algorifonticola, Paenibacillus alkaliterrae, Paenibacillus alvei, Paenibacillus amylolyticus, Paenibacillus anaericanus, Paenibacillus antarcticus, Paenibacillus apiarius, Paenibacillus arachidis, Paenibacillus assamensis, Paenibacillus azoreducens, Paenibacillus azotofixans, Paenibacillus baekrokdamisoli, Paenibacillus barcinonensis, Paenibacillus barengoltzii, Paenibacillus borealis, Paenibacillus bovis, Paenibacillus brasilensis, Paenibacillus camelliae, Paenibacillus campinasensis, Paenibacillus castaneae, Paenibacillus catalpae, Paenibacillus cathormii, Paenibacillus cavernae, Paenibacillus cellulosilyticus, Paenibacillus cellulositrophicus, Paenibacillus chartarius, Paenibacillus chibensis, Paenibacillus chinjuensis, Paenibacillus chitinolyticus, Paenibacillus chondroitinus, Paenibacillus chungangensis, Paenibacillus cineris, Paenibacillus cisolokensis, Paenibacillus contaminans, Paenibacillus cookii, Paenibacillus cucumis, Paenibacillus curdlanolyticus, Paenibacillus daejeonensis, Paenibacillus darwinianus, Paenibacillus dauci, Paenibacillus dendritiformis, Paenibacillus dongdonensis, Paenibacillus doosanensis, Paenibacillus durus, Paenibacillus edaphicus, Paenibacillus ehimensis, Paenibacillus elgii, Paenibacillus endophyticus, Paenibacillus etheri, Paenibacillus faecis, Paenibacillus favisporus, Paenibacillus ferrarius, Paenibacillus filicis, Paenibacillus fonticola, Paenibacillus forsythias, Paenibacillus frigoriresistens, Paenibacillus gansuensis, Paenibacillus gelatinilyticus, Paenibacillus ginsengarvi, Paenibacillus ginsengihumi, Paenibacillus ginsengisoli, Paenibacillus glacialis, Paenibacillus glucanolyticus, Paenibacillus glycanilyticus, Paenibacillus gordonae, Paenibacillus graminis, Paenibacillus granivorans, Paenibacillus guangzhouensis, or Paenibacillus harenae, Paenibacillus hemerocallicola, Paenibacillus hispanicus, Paenibacillus hodogayensis, Paenibacillus hordei, Paenibacillus humicus, Paenibacillus hunanensis, Paenibacillus illinoisensis, Paenibacillus jamilae, Paenibacillus jilunlii, Paenibacillus kobensis, Paenibacillus koleovorans, Paenibacillus konsidensis, Paenibacillus koreensis, Paenibacillus kribbensis, Paenibacillus kyungheensis, Paenibacillus lactis, Paenibacillus larvae, Paenibacillus larvae, Paenibacillus larvae, Paenibacillus lautus, Paenibacillus lemnae, Paenibacillus lentimorbus, Paenibacillus lentus, Paenibacillus liaoningensis, Paenibacillus lupini, Paenibacillus macerans, Paenibacillus macquariensis, Paenibacillus macquariensis, Paenibacillus macquariensis, Paenibacillus marchantiophytorum, Paenibacillus marinisediminis, Paenibacillus massiliensis, Paenibacillus medicaginis, Paenibacillus mendelii, Paenibacillus methanolicus, Paenibacillus montaniterrae, Paenibacillus motobuensis, Paenibacillus mucilaginosus, Paenibacillus nanensis, Paenibacillus nap hthalenovorans, Paenibacillus nasutitermitis, Paenibacillus nematophilus, Paenibacillus nicotianae, Paenibacillus oceanisediminis, Paenibacillus odorifer, Paenibacillus oenotherae, Paenibacillus oryzae, Paenibacillus pabuli, Paenibacillus panacisoli, Paenibacillus panaciterrae, Paenibacillus pasadenensis, Paenibacillus pectinilyticus, Paenibacillus periandrae, Paenibacillus phoenicis, Paenibacillus phyllosphaerae, Paenibacillus physcomitrellae, Paenibacillus pini, Paenibacillus pinihumi, Paenibacillus pinesoli, Paenibacillus pocheonensis, Paenibacillus popilliae, Paenibacillus populi, Paenibacillus prosopidis, Paenibacillus provencensis, Paenibacillus pueri, Paenibacillus puldeungensis, Paenibacillus pulvifaciens, Paenibacillus purispatii, Paenibacillus qingshengii, Paenibacillus quercus, Paenibacillus radicis, Paenibacillus relictisesami, Paenibacillus residui, Paenibacillus rhizoryzae, Paenibacillus rhizosphaerae, Paenibacillus rigui, Paenibacillus riograndensis, Paenibacillus ripae, Paenibacillus sabinae, Paenibacillus sacheonensis, Paenibacillus salinicaeni, Paenibacillus sanguinis, Paenibacillus sediminis, Paenibacillus segetis, Paenibacillus selenii, Paenibacillus selenitireducens, Paenibacillus senegalensis, Paenibacillus septentrionalis, Paenibacillus sepulcri, Paenibacillus shenyangensis, Paenibacillus shirakamiensis, Paenibacillus siamensis, Paenibacillus silagei, Paenibacillus sinopodophylli, Paenibacillus solani, Paenibacillus soli, Paenibacillus sonchi, Paenibacillus sophorae, Paenibacillus sputi, Paenibacillus stellifer, Paenibacillus susongensis, Paenibacillus swuensis, Paenibacillus taichungensis, Paenibacillus taiwanensis, Paenibacillus tarimensis, Paenibacillus telluris, Paenibacillus terrae, Paenibacillus terreus, Paenibacillus terrigena, Paenibacillus thailandensis, Paenibacillus thermophilus, Paenibacillus thiaminolyticus, Paenibacillus tianmuensis, Paenibacillus tibetensis, Paenibacillus timonensis, Paenibacillus tundrae, Paenibacillus turicensis, Paenibacillus typhae, Paenibacillus uliginis, Paenibacillus urinalis, Paenibacillus validus, Paenibacillus vini, Paenibacillus vulneris, Paenibacillus wenxiniae, Paenibacillus wooponensis, Paenibacillus woosongensis, Paenibacillus wulumuqiensis, Paenibacillus wynnii, Paenibacillus xanthinilyticus, Paenibacillus xinjiangensis, Paenibacillus xylanexedens, Paenibacillus xylanilyticus, Paenibacillus xylanisolvens, Paenibacillus yonginensis, Paenibacillus yunnanensis, Paenibacillus zanthoxyli, and Paenibacillus zeae.

In certain aspects, the plant growth-promoting Paenibacillus isolate is Paenibacillus alvei, Paenibacillus amylolyticus, Paenibacillus macerans, Paenibacillus polymyxa, Paenibacillus popilliae, Paenibacillus terrae, or a combination thereof. In one aspect, the plant growth-promoting Paenibacillus isolate is selected from the group consisting of Paenibacillus alvei strain T36, Paenibacillus alvei strain III3DT-1A, Paenibacillus alvei strain III2E, Paenibacillus alvei strain 46C3, Paenibacillus alvei strain 2771, Paenibacillus polymyxa strain AC-1, Paenibacillus sp. strain NRRL B-50972, Paenibacillus sp. strain NRRL B-67129, mutants thereof with all the identifying characteristics of the respective strain, and combinations thereof. In a particular aspect, the plant growth-promoting Paenibacillus isolate is Paenibacillus sp. strain NRRL B-67129 or a mutant thereof with all the identifying characteristics of the strain.

In certain aspects the plant growth-promoting Paenibacillus isolate is Paenibacillus popilliae, product known as milky spore disease from St. Gabriel Laboratories; Paenibacillus polymyxa, in particular strain AC-1 (product known as TOPSEED™ from Green Bio-tech Company Ltd.); or Paenibacillus alvei, in particular strain T36 or strain III3DT-1A or strain III2E or strain 46C3 or strain 2771.

List 1 describes combinations of a plant growth-promoting Bacillus isolate and an inorganic phosphate in a kit of parts and/or to be applied to a plant, a plant part, a plant propagule, a seed of a plant and/or a locus where a plant is growing or is intended to grow to promote spore germination and/or vegetative growth of the plant growth-promoting Bacillus isolate:

List 1: Bacillus subtilis var. amyloliquefaciens strain FZB24+monoammonium phosphate, Bacillus subtilis var. amyloliquefaciens strain FZB24+diammonium phosphate, Bacillus subtilis var. amyloliquefaciens strain FZB24+monopotassium phosphate, Bacillus amyloliquefaciens strain FZB42+monoammonium phosphate, Bacillus amyloliquefaciens strain FZB42+diammonium phosphate, Bacillus amyloliquefaciens strain FZB42+monopotassium phosphate, Bacillus amyloliquefaciens strain D747+monoammonium phosphate, Bacillus amyloliquefaciens strain D747+diammonium phosphate, Bacillus amyloliquefaciens strain D747+monopotassium phosphate, Bacillus subtilis strain Y1336+monoammonium phosphate, Bacillus subtilis strain Y1336+diammonium phosphate, Bacillus subtilis strain Y1336+monopotassium phosphate, Bacillus subtilis strain MBI 600+monoammonium phosphate, Bacillus subtilis strain MBI 600+diammonium phosphate, Bacillus subtilis strain MBI 600+monopotassium phosphate, Bacillus subtilis strain QST713 (Accession No. NRRL B-21661)+monoammonium phosphate, Bacillus subtilis strain QST713 (Accession No. NRRL B-21661)+diammonium phosphate, Bacillus subtilis strain QST713 (Accession No. NRRL B-21661)+monopotassium phosphate, Bacillus subtilis AQ30002 (Accession No. NRRL B-50421)+monoammonium phosphate, Bacillus subtilis AQ30002 (Accession No. NRRL B-50421)+diammonium phosphate, Bacillus subtilis AQ30002 (Accession No. NRRL B-50421)+monopotassium phosphate, Bacillus subtilis AQ30004 (Accession No. NRRL B-50455)+monoammonium phosphate, Bacillus subtilis AQ30004 (Accession No. NRRL B-50455)+diammonium phosphate, Bacillus subtilis AQ30004 (Accession No. NRRL B-50455)+monopotassium phosphate, Bacillus pumilusQST2808 (Accession No. NRRL B-30087)+monoammonium phosphate, Bacillus pumilus QST2808 (Accession No. NRRL B-30087)+diammonium phosphate, Bacillus pumilus QST2808 (Accession No. NRRL B-30087)+monopotassium phosphate, Bacillus subtilis var. amyloliquefaciens strain FZB24+dipotassium phosphate, Bacillus subtilis var. amyloliquefaciens strain FZB24+ammonium polyphosphate, Bacillus subtilis var. amyloliquefaciens strain FZB24+calcium phosphate, Bacillus amyloliquefaciens strain FZB42+dipotassium phosphate, Bacillus amyloliquefaciens strain FZB42+ammonium polyphosphate, Bacillus amyloliquefaciens strain FZB42+calcium phosphate, Bacillus amyloliquefaciens strain D747+dipotassium phosphate, Bacillus amyloliquefaciens strain D747+ammonium polyphosphate, Bacillus amyloliquefaciens strain D747+calcium phosphate, Bacillus subtilis strain Y1336+dipotassium phosphate, Bacillus subtilis strain Y1336+ammonium polyphosphate, Bacillus subtilis strain Y1336+calcium phosphate, Bacillus subtilis strain MBI 600+dipotassium phosphate, Bacillus subtilis strain MBI 600+ammonium polyphosphate, Bacillus subtilis strain MBI 600+calcium phosphate, Bacillus subtilis strain QST713 (Accession No. NRRL B-21661)+dipotassium phosphate, Bacillus subtilis strain QST713 (Accession No. NRRL B-21661)+ammonium polyphosphate, Bacillus subtilis strain QST713 (Accession No. NRRL B-21661)+calcium phosphate, Bacillus subtilis AQ30002 (Accession No. NRRL B-50421)+dipotassium phosphate, Bacillus subtilis AQ30002 (Accession No. NRRL B-50421)+ammonium polyphosphate, Bacillus subtilis AQ30002 (Accession No. NRRL B-50421)+calcium phosphate, Bacillus subtilis AQ30004 (Accession No. NRRL B-50455)+dipotassium phosphate, Bacillus subtilis AQ30004 (Accession No. NRRL B-50455)+ammonium polyphosphate, Bacillus subtilis AQ30004 (Accession No. NRRL B-50455)+calcium phosphate, Bacillus pumilus QST2808 (Accession No. NRRL B-30087)+dipotassium phosphate, Bacillus pumilus QST2808 (Accession No. NRRL B-30087)+ammonium polyphosphate, Bacillus pumilus QST2808 (Accession No. NRRL B-30087)+calcium phosphate, Bacillus subtilis var. amyloliquefaciens strain FZB24+magnesium phosphate, Bacillus subtilis var. amyloliquefaciens strain FZB24+zinc phosphate, Bacillus subtilis var. amyloliquefaciens strain FZB24+manganese phosphate, Bacillus amyloliquefaciens strain FZB42+magnesium phosphate, Bacillus amyloliquefaciens strain FZB42+zinc phosphate, Bacillus amyloliquefaciens strain FZB42+manganese phosphate, Bacillus amyloliquefaciens strain D747+magnesium phosphate, Bacillus amyloliquefaciens strain D747+zinc phosphate, Bacillus amyloliquefaciens strain D747+manganese phosphate, Bacillus subtilis strain Y1336+magnesium phosphate, Bacillus subtilis strain Y1336+zinc phosphate, Bacillus subtilis strain Y1336+manganese phosphate, Bacillus subtilis strain MBI 600+magnesium phosphate, Bacillus subtilis strain MBI 600+zinc phosphate, Bacillus subtilis strain MBI 600+manganese phosphate, Bacillus subtilis strain QST713 (Accession No. NRRL B-21661)+magnesium phosphate, Bacillus subtilis strain QST713 (Accession No. NRRL B-21661)+zinc phosphate, Bacillus subtilis strain QST713 (Accession No. NRRL B-21661)+manganese phosphate, Bacillus subtilis AQ30002 (Accession No. NRRL B-50421)+magnesium phosphate, Bacillus subtilis AQ30002 (Accession No. NRRL B-50421)+zinc phosphate, Bacillus subtilis AQ30002 (Accession No. NRRL B-50421)+manganese phosphate, Bacillus subtilis AQ30004 (Accession No. NRRL B-50455)+magnesium phosphate, Bacillus subtilis AQ30004 (Accession No. NRRL B-50455)+zinc phosphate, Bacillus subtilis AQ30004 (Accession No. NRRL B-50455)+manganese phosphate, Bacillus pumilus QST2808 (Accession No. NRRL B-30087)+magnesium phosphate, Bacillus pumilus QST2808 (Accession No. NRRL B-30087)+zinc phosphate, Bacillus pumilus QST2808 (Accession No. NRRL B-30087)+manganese phosphate, Bacillus subtilis var. amyloliquefaciens strain FZB24+iron phosphate, Bacillus subtilis var. amyloliquefaciens strain FZB24+potassium phosphite, Bacillus subtilis var. amyloliquefaciens strain FZB24+copper phosphate, Bacillus amyloliquefaciens strain FZB42+iron phosphate, Bacillus amyloliquefaciens strain FZB42+potassium phosphite, Bacillus amyloliquefaciens strain FZB42+copper phosphate, Bacillus amyloliquefaciens strain D747+iron phosphate, Bacillus amyloliquefaciens strain D747+potassium phosphite, Bacillus amyloliquefaciens strain D747+copper phosphate, Bacillus subtilis strain Y1336+iron phosphate, Bacillus subtilis strain Y1336+potassium phosphite, Bacillus subtilis strain Y1336+copper phosphate, Bacillus subtilis strain MBI 600+iron phosphate, Bacillus subtilis strain MBI 600+potassium phosphite, Bacillus subtilis strain MBI 600+copper phosphate, Bacillus subtilis strain QST713 (Accession No. NRRL B-21661)+iron phosphate, Bacillus subtilis strain QST713 (Accession No. NRRL B-21661)+potassium phosphite, Bacillus subtilis strain QST713 (Accession No. NRRL B-21661)+copper phosphate, Bacillus subtilis AQ30002 (Accession No. NRRL B-50421)+iron phosphate, Bacillus subtilis AQ30002 (Accession No. NRRL B-50421)+potassium phosphite, Bacillus subtilis AQ30002 (Accession No. NRRL B-50421)+copper phosphate, Bacillus subtilis AQ30004 (Accession No. NRRL B-50455)+iron phosphate, Bacillus subtilis AQ30004 (Accession No. NRRL B-50455)+potassium phosphite, Bacillus subtilis AQ30004 (Accession No. NRRL B-50455)+copper phosphate, Bacillus pumilus QST2808 (Accession No. NRRL B-30087)+iron phosphate, Bacillus pumilus QST2808 (Accession No. NRRL B-30087)+potassium phosphite, Bacillus pumilus QST2808 (Accession No. NRRL B-30087)+copper phosphate.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.1 mM and about 100 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.1 mM and about 50 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.1 mM and about 30 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.25 mM and about 100 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.25 mM and about 50 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.25 mM and about 30 mM.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.1 mg/mL and about 5 mg/mL.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.1 mg/mL and about 2.5 mg/mL.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.3 mg/mL and about 5 mg/mL.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.3 mg/mL and about 2.5 mg/mL.

In one embodiment, the method of promoting spore germination and/or vegetative growth of a plant growth-promoting Bacillus isolate comprises applying any one of the combinations as disclosed in List 1 to a plant, a plant part, a plant propagule, a seed of a plant and/or a locus where a plant is growing or is intended to grow at a concentration of inorganic phosphate of between about 0.3 mg/mL and about 2 mg/mL.

List 2 describes combinations of a plant growth-promoting Paenibacillus isolate and an inorganic phosphate in a kit of parts and/or to be applied to a plant, a plant part, a plant propagule, a seed of a plant and/or a locus where a plant is growing or is intended to grow to promote spore germination and/or vegetative growth of the plant growth-promoting Paenibacillus isolate:

List 2: Paenibacillus alvei strain T36+monoammonium phosphate, Paenibacillus alvei strain T36+diammonium phosphate, Paenibacillus alvei strain T36+monopotassium phosphate, Paenibacillus alvei strain III3DT-1A+monoammonium phosphate, Paenibacillus alvei strain III3DT-1A+diammonium phosphate, Paenibacillus alvei strain III3DT-1A+monopotassium phosphate, Paenibacillus alvei strain III2E+monoammonium phosphate, Paenibacillus alvei strain III2E+diammonium phosphate, Paenibacillus alvei strain III2E+monopotassium phosphate, Paenibacillus alvei strain 46C3+monoammonium phosphate, Paenibacillus alvei strain 46C3+diammonium phosphate, Paenibacillus alvei strain 46C3+monopotassium phosphate, Paenibacillus alvei strain 2771+monoammonium phosphate, Paenibacillus alvei strain 2771+diammonium phosphate, Paenibacillus alvei strain 2771+monopotassium phosphate, Paenibacillus polymyxa strain AC-1+monoammonium phosphate, Paenibacillus polymyxa strain AC-1+diammonium phosphate, Paenibacillus polymyxa strain AC-1+monopotassium phosphate, Paenibacillus sp. strain NRRL B-50972+monoammonium phosphate, Paenibacillus sp. strain NRRL B-50972+diammonium phosphate, Paenibacillus sp. strain NRRL B-50972+monopotassium phosphate, Paenibacillus sp. strain NRRL B-67129+monoammonium phosphate, Paenibacillus sp. strain NRRL B-67129+diammonium phosphate, Paenibacillus sp. strain NRRL B-67129+monopotassium phosphate, Paenibacillus alvei strain T36+dipotassium phosphate, Paenibacillus alvei strain T36+ammonium polyphosphate, Paenibacillus alvei strain T36+calcium phosphate, Paenibacillus alvei strain III3DT-1A+dipotassium phosphate, Paenibacillus alvei strain III3DT-1A+ammonium polyphosphate, Paenibacillus alvei strain III3DT-1A+calcium phosphate, Paenibacillus alvei strain III2E+dipotassium phosphate, Paenibacillus alvei strain III2E+ammonium polyphosphate, Paenibacillus alvei strain III2E+calcium phosphate, Paenibacillus alvei strain 46C3+dipotassium phosphate, Paenibacillus alvei strain 46C3+ammonium polyphosphate, Paenibacillus alvei strain 46C3+calcium phosphate, Paenibacillus alvei strain 2771+dipotassium phosphate, Paenibacillus alvei strain 2771+ammonium polyphosphate, Paenibacillus alvei strain 2771+calcium phosphate, Paenibacillus polymyxa strain AC-1+dipotassium phosphate, Paenibacillus polymyxa strain AC-1+ammonium polyphosphate, Paenibacillus polymyxa strain AC-1+calcium phosphate, Paenibacillus sp. strain NRRL B-50972+dipotassium phosphate, Paenibacillus sp. strain NRRL B-50972+ammonium polyphosphate, Paenibacillus sp. strain NRRL B-50972+calcium phosphate, Paenibacillus sp. strain NRRL B-67129+dipotassium phosphate, Paenibacillus sp. strain NRRL B-67129+ammonium polyphosphate, Paenibacillus sp. strain NRRL B-67129+calcium phosphate, Paenibacillus alvei strain T36+magnesium phosphate, Paenibacillus alvei strain T36+zinc phosphate, Paenibacillus alvei strain T36+manganese phosphate, Paenibacillus alvei strain III3DT-1A+magnesium phosphate, Paenibacillus alvei strain III3DT-1A+zinc phosphate, Paenibacillus alvei strain III3DT-1A+manganese phosphate, Paenibacillus alvei strain III2E+magnesium phosphate, Paenibacillus alvei strain III2E+zinc phosphate, Paenibacillus alvei strain III2E+manganese phosphate, Paenibacillus alvei strain 46C3+magnesium phosphate, Paenibacillus alvei strain 46C3+zinc phosphate, Paenibacillus alvei strain 46C3+manganese phosphate, Paenibacillus alvei strain 2771+magnesium phosphate, Paenibacillus alvei strain 2771+zinc phosphate, Paenibacillus alvei strain 2771+manganese phosphate, Paenibacillus polymyxa strain AC-1+magnesium phosphate, Paenibacillus polymyxa strain AC-1+zinc phosphate, Paenibacillus polymyxa strain AC-1+manganese phosphate, Paenibacillus sp. strain NRRL B-50972+magnesium phosphate, Paenibacillus sp. strain NRRL B-50972+zinc phosphate, Paenibacillus sp. strain NRRL B-50972+manganese phosphate, Paenibacillus sp. strain NRRL B-67129+magnesium phosphate, Paenibacillus sp. strain NRRL B-67129+zinc phosphate, Paenibacillus sp. strain NRRL B-67129+manganese phosphate, +magnesium phosphate, +zinc phosphate, +manganese phosphate, Paenibacillus alvei strain T36+iron phosphate, Paenibacillus alvei strain T36+potassium phosphite, Paenibacillus alvei strain T36 +copper phosphate, Paenibacillus alvei strain III3DT-1A+iron phosphate, Paenibacillus alvei strain III3DT-1A+potassium phosphite, Paenibacillus alvei strain III3DT-1A+copper phosphate, Paenibacillus alvei strain III2E+iron phosphate, Paenibacillus alvei strain III2E+potassium phosphite, Paenibacillus alvei strain III2E+copper phosphate, Paenibacillus alvei strain 46C3+iron phosphate, Paenibacillus alvei strain 46C3+potassium phosphite, Paenibacillus alvei strain 46C3+copper phosphate, Paenibacillus alvei strain 2771+iron phosphate, Paenibacillus alvei strain 2771+potassium phosphite, Paenibacillus alvei strain 2771+copper phosphate, Paenibacillus polymyxa strain AC-1+iron phosphate, Paenibacillus polymyxa strain AC-1+potassium phosphite, Paenibacillus polymyxa strain AC-1+copper phosphate, Paenibacillus sp. strain NRRL B-50972+iron phosphate, Paenibacillus sp. strain NRRL B-50972+potassium phosphite, Paenibacillus sp. strain NRRL B-50972+copper phosphate, Paenibacillus sp. strain NRRL B-67129+iron phosphate, Paenibacillus sp. strain NRRL B-67129+potassium phosphite, Paenibacillus sp. strain NRRL B-67129+copper phosphate.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.1 mM and about 100 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.1 mM and about 50 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.1 mM and about 30 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.25 mM and about 100 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.25 mM and about 50 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.25 mM and about 30 mM.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.1 mg/mL and about 5 mg/mL.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.1 mg/mL and about 2.5 mg/mL.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.3 mg/mL and about 5 mg/mL.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.3 mg/mL and about 2.5 mg/mL.

In one embodiment, the method of promoting spore germination and/or vegetative growth of a plant growth-promoting Paenibacillus isolate comprises applying any one of the combinations as disclosed in List 2 to a plant, a plant part, a plant propagule, a seed of a plant and/or a locus where a plant is growing or is intended to grow at a concentration of inorganic phosphate of between about 0.3 mg/mL and about 2 mg/mL.

In some embodiments, the Bacillus sp. cells are Bacillus subtilis strain with Accession No. NRRL B-21661 (also known as Bacillus subtilis QST713) or a mutant thereof having all the identifying characteristics of the strain. Bacillus subtilis QST713, its mutants, its supernatants, and its lipopeptide metabolites, and methods for their use to control plant pathogens and insects are fully described in U.S. Pat. Nos. 6,060,051; 6,103,228; 6,291,426; 6,417,163; and 6,638,910. In these patents, the strain is referred to as AQ713, which is synonymous with QST713. Any references in this specification to QST713 refer to Bacillus subtilis QST713. Particular variants of Bacillus subtilis QST713 (e.g., Bacillus subtilis AQ30002 and AQ30004, deposited as Accession Numbers NRRL B-50421 and NRRL B-50455) that would also be suitable for the present invention are described in U.S. Patent Application Publication No. 2012/0231951.

At the time of filing U.S. patent application Ser. No. 09/074,870 in 1998, which corresponds to the above patents, the strain was designated as Bacillus subtilis based on classical, physiological, biochemical and morphological methods. Taxonomy of the Bacillus species has evolved since then, especially in light of advances in genetics and sequencing technologies, such that species designation is based largely on DNA sequence rather than the methods used in 1998. After aligning protein sequences from B. amyloliquefaciens FZB42, B. subtilis 168 and QST713, approximately 95% of proteins found in B. amyloliquefaciens FZB42 are 85% or greater identical to proteins found in QST713; whereas only 35% of proteins in B. subtilis 168 are 85% or greater identical to proteins in QST713. However, even with the greater reliance on genetics, there is still taxonomic ambiguity in the relevant scientific literature and regulatory documents, reflecting the evolving understanding of Bacillus taxonomy over the past 15 years. For example, a pesticidal product based on B. subtilis strain FZB24, which is as closely related to QST713 as FZB42, is classified in documents of the U.S. EPA as B. subtilis var. amyloliquefaciens. Due to these complexities in nomenclature, this particular Bacillus species is variously designated, depending on the document, as B. subtilis, B. amyloliquefaciens, and B. subtilis var. amyloliquefaciens. Therefore, we have retained the B. subtilis designation of QST713 rather than changing it to B. amyloliquefaciens, as would be expected currently based solely on sequence comparison and inferred taxonomy.

The SERENADE® product (U.S. EPA Registration No. 69592-12) contains a patented strain of Bacillus subtilis (strain QST713) and many different lipopeptides that act together to destroy disease pathogens and provide superior antimicrobial activity. The SERENADE® product is used to protect plants such as vegetables, fruit, nut, and vine crops against diseases such as Fire Blight, Botrytis, Sour Rot, Rust, Sclerotinia, Powdery Mildew, Bacterial Spot and White Mold. The SERENADE® products are available as either liquid or dry formulations which can be applied as a foliar and/or soil treatment. Copies of U.S. EPA Master Labels for the SERENADE® products, including SERENADE® ASO, SERENADE® MAX, and SERENADE SOIL®, are publicly available through National Pesticide Information Retrieval System's (NPIRS) USEPA/OPP Pesticide Product Label System (PPLS).

Other Bacillus sp. strains are capable of being used with the methods described herein. For example, Bacillus amyloliquefaciens strain D747 (available as BACSTAR® from Etec Crop Solutions, NZ and also available as DOUBLE NICKEL® from Certis, US); Bacillus subtilis MBI 600 (available as SUBTILEX® from Becker Underwood, U.S. EPA Reg. No. 71840-8); Bacillus subtilis Y1336 (available as BIOBAC® WP from Bion-Tech, Taiwan, registered as a biological fungicide in Taiwan under Registration Nos. 4764, 5454, 5096 and 5277); Bacillus amyloliquefaciens, in particular strain FZB42 (available as RHIZOVITAL® from ABiTEP, DE); and Bacillus subtilis var. amyloliquefaciens FZB24 is available from Novozymes Biologicals Inc. (Salem, Virginia) or Syngenta Crop Protection, LLC (Greensboro, North Carolina) as the fungicide TAEGRO® or TAEGRO® ECO (EPA Registration No. 70127-5), are all Bacillus strains capable of being processed to produce a suspension concentrate as described herein.

A mutant of FZB24 that was assigned Accession No. NRRL B-50349 by the Agricultural Research Service Culture Collection is also described in U.S. Patent Application Publication No. 2011/0230345. Bacillus amyloliquefaciens FZB42 is available from ABiTEP GMBH, Germany, as the plant strengthening product RHIZOVITAL®; FZB42 is also described in European Patent Publication No. EP2179652, and also in Chen, et al., “Comparative Analysis of the Complete Genome Sequence of the Plant Growth-Promoting Bacterium Bacillus amyloliquefaciens FZB42,” Nature Biotechnology, Volume 25, Number 9 (September 2007). Mutants of FZB42 are described in International Publication No. WO 2012/130221, including Bacillus amyloliquefaciens ABI01, which was assigned Accession No. DSM 10-1092 by the DSMZ—German Collection of Microorganisms and Cell Cultures.

In some embodiments, any one of the following Bacillus strains may be used with the methods, compositions, and fermentation products of the present invention: Bacillus subtilis GBO₃ (available as KODIAK® from Bayer CropScience, U.S. EPA Reg. No. 264-970) or Bacillus amyloliquefaciens strain IN937a, or Bacillus amyloliquefaciens strain FZB42 (DSM 231179, product known as RHIZO VITAL® from ABiTEP, DE); or Bacillus subtilis strain B3, or Bacillus subtilis strain D747, (products known as BACSTAR® from Etec Crop Solutions, NZ, or DOUBLE NICKEL® from Certis, US); Bacillus subtilis strain GBO₃ (Accession No. ATCC SD-1397, product known as KODIAK® from Bayer CropScience, DE, U.S. EPA Reg. No. 264-970) or Bacillus subtilis strain QST713/AQ713 (Accession No. NRRL B-21661, products known as SERENADE® from Bayer CropScience) or Bacillus subtilis strain AQ153 (ATCC Accession No. 55614) or Bacillus sp. strain AQ743 (Accession No. NRRL B-21665) or Bacillus subtilis strain DB 101, (products known as SHELTER™ from Dagutat Bio lab, ZA); or Bacillus subtilis strain DB 102, (products known as ARTEMIS™ from Dagutat Bio lab, ZA); or Bacillus subtilis strain MBI 600, (products known as SUBTILEX® from Becker Underwood, U.S.); or Bacillus subtilis strain QST30002/AQ30002 (Accession No. NRRL B-50421, cf. WO 2012/087980) or Bacillus subtilis strain QST30004/AQ30004 (Accession No. NRRL B-50455, cf. WO 2012/087980), or Bacillus subtilis strain BSY 1336, (products known as BIBONG® from Kuanghwa Chemical Co. Ltd., Taiwan); or Bacillus subtilis strain BD 170, (products known as BIOPRO® from Adermatt Biocontrol, Europe); or Bacillus subtilis strain B2g, (products known as PHYTOVIT® from Prophyta, Germany); or Bacillus subtilis strain BSF4, (products known as BSF4® from Agribiotec, Italy); or Bacillus subtilis strain B246, (products known as AVOGREEN® from the University of Pretoria in South Africa); Bacillus sp. strain GB99 or Bacillus sp. strain GB122 (products known as BIOYIELD®); or Bacillus subtilis strain KTSB, (products known as FOLIACTIVE® from Donaghys, New Zealand); or Bacillus subtilis strain Antumavida or Bacillus subtilis strain VilcUn, (products known as NACILLUS® from Bio Insumos Nativa Ltda., Chile); or Bacillus subtilis strain BSY1336, (products known as BIOBAC® from Bion Tech Inc., Taiwan); or Bacillus subtilis strain WG6-14, (products known as BACTOPHYT® from Novosibirsk, Russia); or Bacillus subtilis strain KTS, (products known as KILL DEW® DP from Krishi-Mitra, Turkey); or Bacillus subtilis strain MBI 600, (products known as BOTOKILLER® from Idemitsu Kosan Co., Korea); or Bacillus amyloliquefaciens strain BS lb, (products known as TRIPLEX® from BioStart Limited, New Zealand); or Bacillus subtilis strain BS-K423, (products known as UNGSAMI® from Shin Young Agro Co., Ltd., Korea); or Bacillus subtilis strain PB6, (products known as CLOSTAT® from Kemin, USA); or Bacillus subtilis strain KPS46; or Bacillus subtilis strain C06; or Bacillus subtilis strain JKK 238; or Bacillus subtilis strain EB120; or Bacillus subtilis strain KB401.

This invention is further illustrated by the following additional examples that should not be construed as limiting. Those of skill in the art should, in light of the present disclosure, appreciate that many changes can be made to the specific embodiments which are disclosed and still obtain a like or similar result without departing from the spirit and scope of the invention.

### DEPOSIT INFORMATION

A sample of a Bacillus subtilis strain of the invention has been deposited with the Agricultural Research Service Culture Collection located at the National Center for Agricultural Utilization Research, Agricultural Research Service, U.S. Department of Agriculture, 1815 North University Street, Peoria, Ill. 61604, U.S.A., under the Budapest Treaty on Mar. 7, 1997, and has been assigned Accession Number NRRL B-21661.

Samples of QST30002 (aka AQ30002) and QST30004 (aka AQ30004) have been deposited with the Agricultural Research Service Culture Collection under the Budapest Treaty on Oct. 5, 2010, and Dec. 6, 2010, respectively. QST30002 has been assigned Accession Number NRRL B-50421, and QST30004 has been assigned the following Accession Number NRRL B-50455.

The Bacillus subtilis strains has been deposited under conditions that assure that access to the culture will be available during the pendency of this patent application to one determined by the Commissioner of Patents and Trademarks to be entitled thereto under 37 C.F.R. § 1.14 and 35 U.S.C. § 122. The deposits represent a substantially pure culture of the deposited Bacillus subtilis strain. The deposits are available as required by foreign patent laws in countries wherein counterparts of the subject application or its progeny are filed. However, it should be understood that the availability of a deposit does not constitute a license to practice the subject invention in derogation of patent rights granted by governmental action.

The following examples are given for purely illustrative and non-limiting purposes of the present invention.

### EXAMPLES

### Example 1

### Evaluation of Effects of SERENADE® (Bacillus subtilis strain QST713) and Triple Superphosphate on Potatoes

A field trial was conducted in Hatay Province in Turkey to evaluate the effects of applying SERENADE® (Bacillus subtilis strain QST713) to potatoes grown under standard local practices. All potatoes were treated with Triple Superphosphate (also known as TSP and Ca(H₂PO₄)₂.H₂O). SERENADE® (Bacillus subtilis strain QST713) was applied at 10 liters per hectare, and TSP was applied at 600 kg per hectare. Both SERENADE® (Bacillus subtilis strain QST713) and TSP were applied at planting. Four replicates of each treatment were included in the field trial.

At harvest the tuber weights were measured across each of the replicates. Potatoes treated with both TSP and SERENADE® (Bacillus subtilis strain QST713) had an average 19% increase in tuber weight amounting to an average increase of 13.8 grams per tuber over potatoes treated with TSP alone (see Table 1).

A similar increase in yield was observed. Potatoes treated with both TSP and SERENADE® (Bacillus subtilis strain QST713) had an average 43% increase in yield amounting to an average increase of 1978 kilograms per decare (kg/da) over potatoes treated with TSP alone (see Table 2).

Not only were tuber weights and yields increased when potatoes were treated with both TSP and SERENADE® (Bacillus subtilis strain QST713) but the average tuber grading was also improved. Harvested potatoes in the two treatment groups were separated according to tuber grading with “First Quality” tubers having the highest grading followed by “Second Quality” and “Third Quality”. In the treatment groups with both TSP and SERENADE® (Bacillus subtilis strain QST713) the numbers of potatoes were increased across each of the tuber grading types compared to the corresponding numbers of potatoes treated with TSP alone (see Table 3). Importantly, the numbers of potatoes in the “First Quality” grading demonstrated the greatest increase when treated with TSP and SERENADE® (Bacillus subtilis strain QST713) compared to potatoes treated with TSP alone.

These field trial results indicate that application of SERENADE® (Bacillus subtilis strain QST713) in combination with inorganic phosphate provides additional yield and quality based on improved tuber formation and increased tuber weight.

TABLE 1
Tuber weights of potatoes treated with TSP alone or with TSP and
SERENADE ® (Bacillus subtilis strain QST713)

| | | Tuber | | |
|---|---|---|---|---|
| | Tuber | Weight | Weight Increase | Weight Increase |
| | Weight | TSP + | TSP + QST713 | TSP + QST713 |
| Repli- | TSP Alone | QST713 | vs. TSP Alone | vs. TSP Alone |
| cate | (g/tuber) | (g/tuber) | (g/tuber) | (%) |
| A | 71.1 | 90.4 | 19.3 | 27% |
| B | 72.0 | 91.9 | 19.8 | 28% |
| C | 69.3 | 96.8 | 27.5 | 40% |
| D | 78.4 | 72.3 | −6.1 | −8% |
| Average | 72.8 | 86.6 | 13.8 | 19% |

TABLE 2
Yields of potatoes treated with TSP alone
or with TSP and SERENADE ® (Bacillus subtilis
strain QST713)

| | | | Yield Increase | Yield Increase |
|---|---|---|---|---|
| | Potato Yield | Potato Yield | TSP + QST713 | TSP + QST713 |
| Repli- | TSP Alone | TSP + QST713 | vs. TSP Alone | vs. TSP Alone |
| cate | (kg/da) | (kg/da) | (kg/da) | (%) |
| A | 3535 | 6477 | 2942 | 83% |
| B | 3760 | 5829 | 2069 | 55% |
| C | 5347 | 7046 | 1699 | 32% |
| D | 5587 | 6790 | 1203 | 22% |
| Average | 4557 | 6535 | 1978 | 43% |

TABLE 3
Average tuber grading of potatoes treated with TSP alone or with TSP
and SERENADE ® (Bacillus subtilis strain QST713)

| | First Quality | | Second Quality | | Third Quality | |
|---|---|---|---|---|---|---|
| | Weight | Number | Weight | Number | Weight | Number |
| | (kg/da) | per da | (kg/da) | per da | (kg/da) | per da |
| TSP Alone | 1068 | 3524 | 1925 | 12143 | 1565 | 46905 |
| TSP + QST713 | 1710 | 5190 | 2457 | 14857 | 2368 | 55381 |
| Increase | 642 | 1667 | 532 | 2714 | 804 | 8476 |
| (kg/da or | | | | | | |
| number/da) | | | | | | |
| Increase | 60% | 47% | 28% | 22% | 51% | 18% |
| (%) | | | | | | |

### Example 2

### Confirmation of Yield Effect of SERENADE® (Bacillus subtilis strain QST713) and Triple Superphosphate on Potatoes

Additional field trials were conducted in the cities of Ankara, Izmir, and Adana in Turkey to confirm the yield effect of applying SERENADE® (Bacillus subtilis strain QST713) to potatoes grown under standard local practices with TSP. SERENADE® (Bacillus subtilis strain QST713) and TSP were applied at planting at the same application rates indicated in Example 1.

At harvest, the potato yields were evaluated in each field trial. Across all three trials, potatoes treated with both TSP and SERENADE® (Bacillus subtilis strain QST713) had a greater yield than did potatoes treated with TSP alone (see Table 4). These results confirmed that application of SERENADE® (Bacillus subtilis strain QST713) in combination with inorganic phosphate provides additional yield.

TABLE 4
Potato yield (kg/da) after application of TSP alone or TSP and
SERENADE ® (Bacillus subtilis strain QST713)

| | | | Yield Increase | Yield Increase |
|---|---|---|---|---|
| Trial | Potato Yield | Potato Yield | TSP + QST713 | TSP + QST713 |
| Loca- | TSP Alone | TSP + QST713 | vs. TSP Alone | vs. TSP Alone |
| tion | (kd/da) | (kg/da) | (kg/da) | (%) |
| Ankara | 5216 | 8624 | 3408 | 65% |
| Izmir | 3100 | 4143 | 1043 | 34% |
| Adana | 9480 | 10825 | 1345 | 14% |

### Example 3

### Evaluation of the Effect of Monopotassium Phosphate on Germination and Growth of Bacillus subtilis QST713 Bacterial Spores

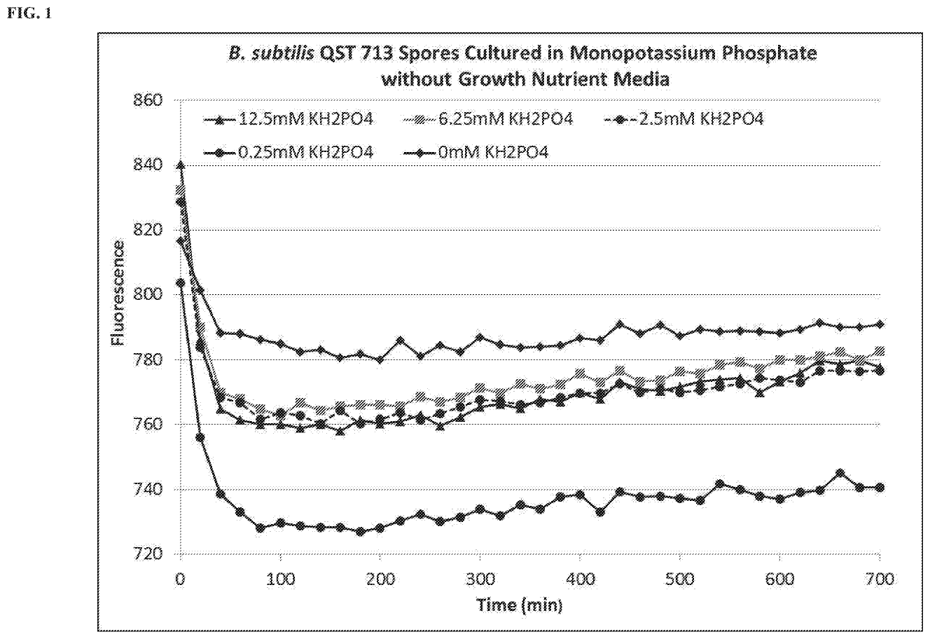

To determine the effect of inorganic phosphate on the germination and vegetative growth of Bacillus spores a preparation of purified spores of Bacillus subtilis QST713 was cultured in minimal media containing concentrations of monopotassium phosphate (KH₂PO₄) of 0.25 mM, 2.5 mM, 6.25 mM, or 12.5 mM and compared to a control containing no monopotassium phosphate. The metabolic activity of germinating and actively growing bacterial spores was monitored with the PRESTOBLUE® cell viability reagent (Invitrogen, Carlsbad, Calif.). Metabolically active cells reduce the PRESTOBLUE® cell viability reagent and generate a fluorescent chemical product that provides a quantitative measure of growing cells. In the absence of growth nutrient media (i.e., without a carbon source) the monopotassium phosphate did not stimulate the germination or growth of the Bacillus subtilis QST713 spores (see FIG. 1).

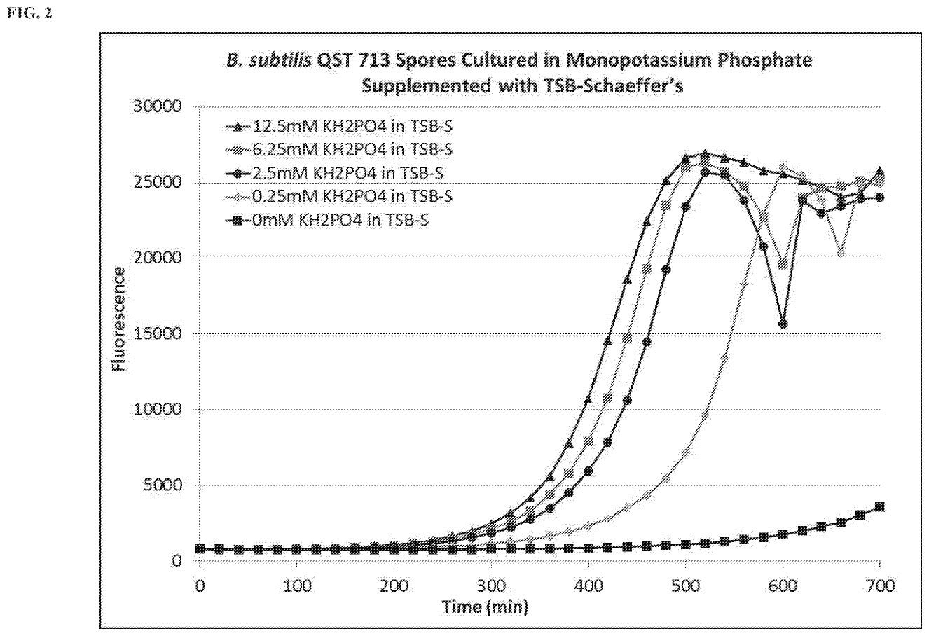

The purified spores of Bacillus subtilis QST713 were then cultured in TSB-Schaeffer's Medium or “TSB-S” containing 8 g/L tryptic soy broth, 1.0 g/L KCl, 0.12 g/L MgSO₄.7H₂O, 0.24 g/L Ca₂NO₃.4H₂O, 2.0 mg/L MnCl₂, and 0.28 mg/L FeSO₄. Monopotassium phosphate (KH₂PO₄) was added to the cultures at concentrations of 0.25 mM, 2.5 mM, 6.25 mM, or 12.5 mM and compared to a control with TSB-S containing no monopotassium phosphate. With the carbon source provided by the TSB-S, the monopotassium phosphate stimulated earlier bacterial spore germination and growth compared to TSB-S alone (see FIG. 2). A dose response was observed with increasing concentrations of monopotassium phosphate stimulating earlier bacterial spore germination and growth (compare 0.25 mM KH₂PO₄ and 12.5 mM KH₂PO₄ in FIG. 2).

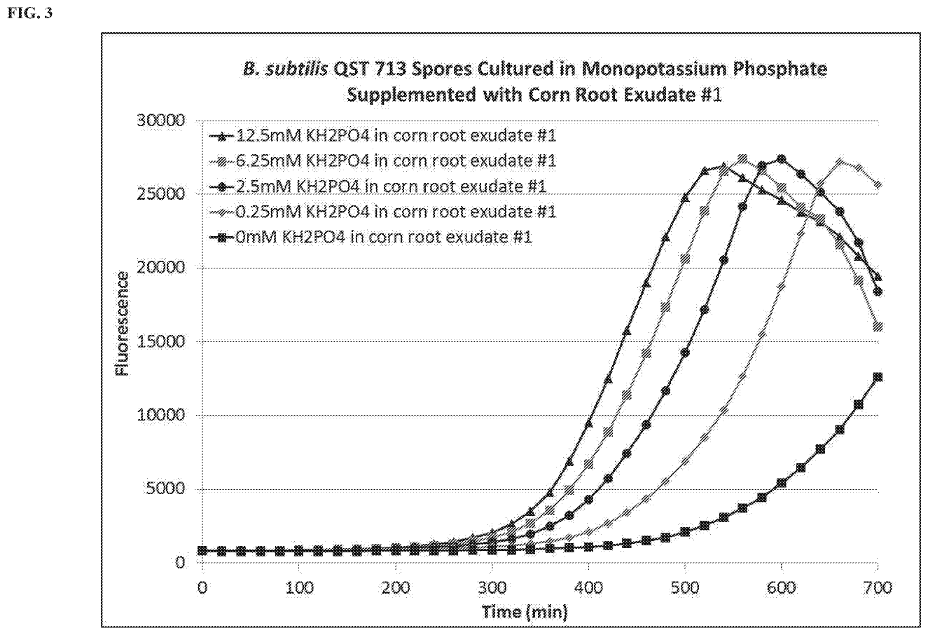

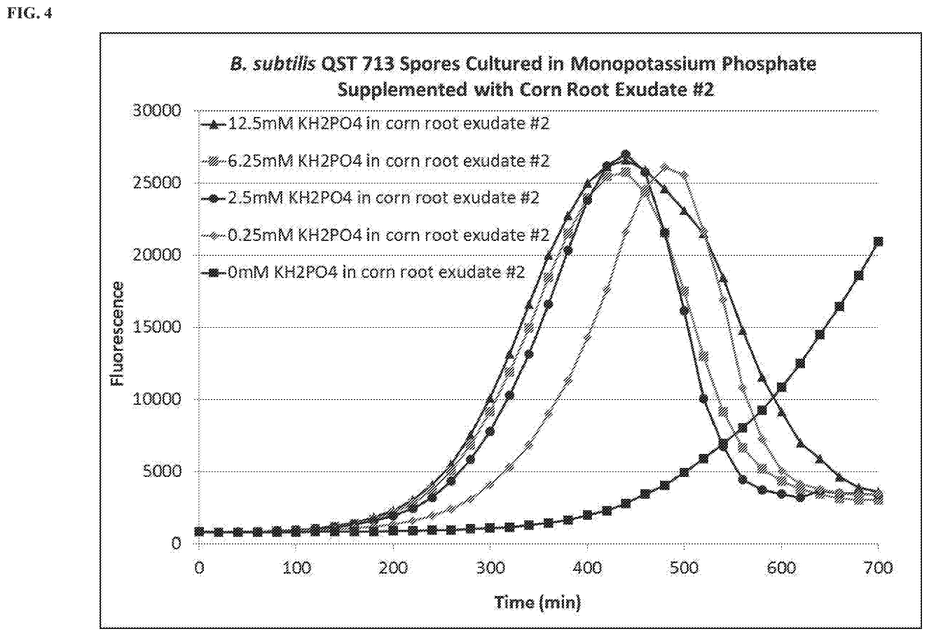

To mimic the environment that the bacterial spores experience in planta exudate was collected from corn roots and used in place of the TSB-S. Consistent with the observations with TSB-S supplemented with monopotassium phosphate, Bacillus subtilis QST713 spores cultured in corn root exudate with monopotassium phosphate experienced earlier germination and growth and showed a similar dose response (see FIG. 3). This experiment was repeated with corn root exudate collected from another variety of corn, and the same effect of monopotassium phosphate on bacterial spore germination and growth was observed (see FIG. 4).

### Example 4

### Evaluation of the Effect of Monopotassium Phosphate on Germination and Growth of Bacterial Spores from Other Bacillus Strains

To determine if the effect of monopotassium phosphate on bacterial spore germination and growth could be observed with other Bacillus strains, spores of Bacillus subtilis MBI 600, Bacillus subtilis GBO₃, Bacillus pumilus QST2808, and Bacillus amyloliquefaciens FZB24 were purified. Each type of purified bacterial spores was cultured in TSB-S alone or TSB-S supplemented with 0.3 mM, 7.5 mM, 15 mM, or 30 mM monopotassium phosphate (KH₂PO₄). The PRESTOBLUE® cell viability reagent was again used as a quantitative measure of metabolically active cells.

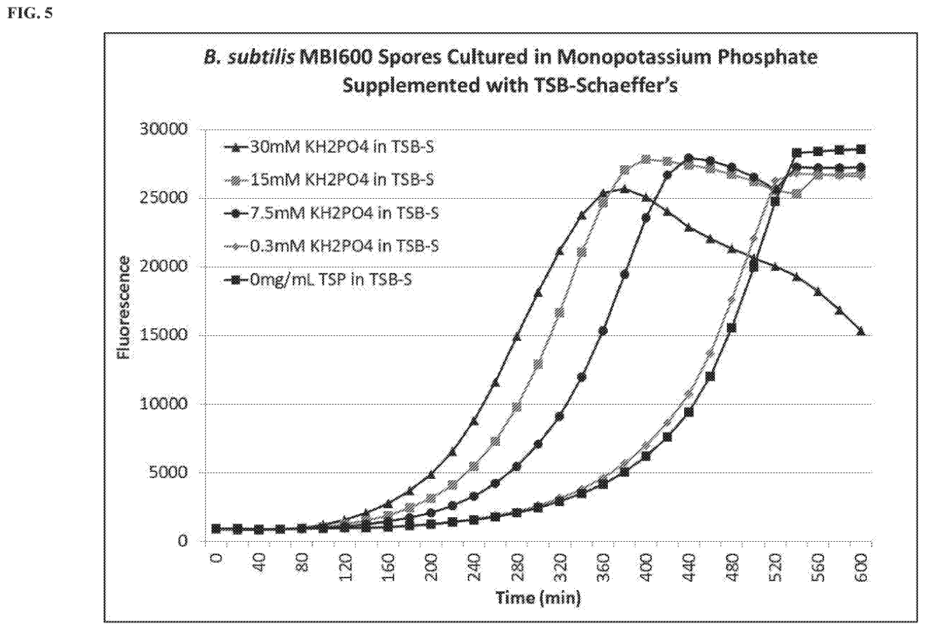

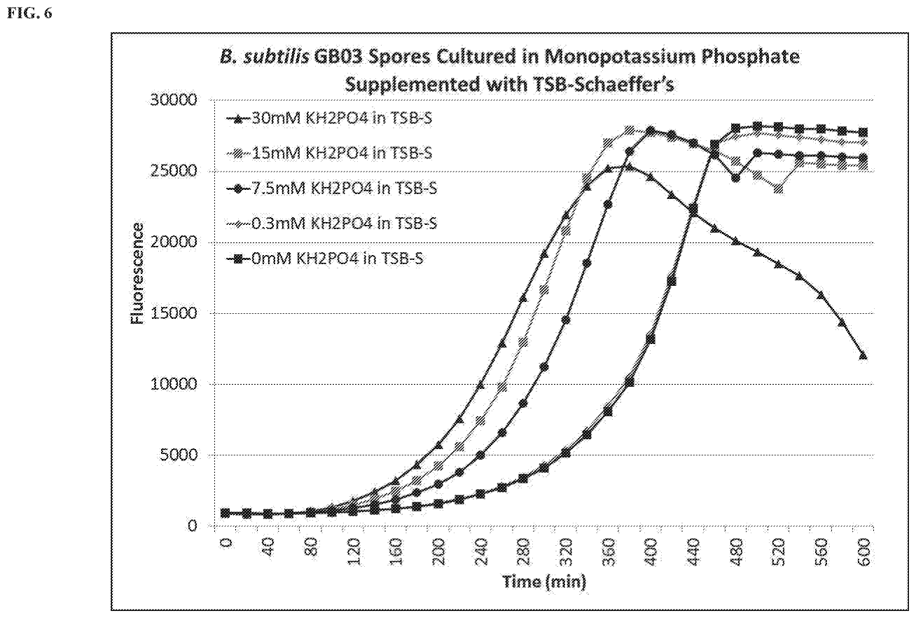

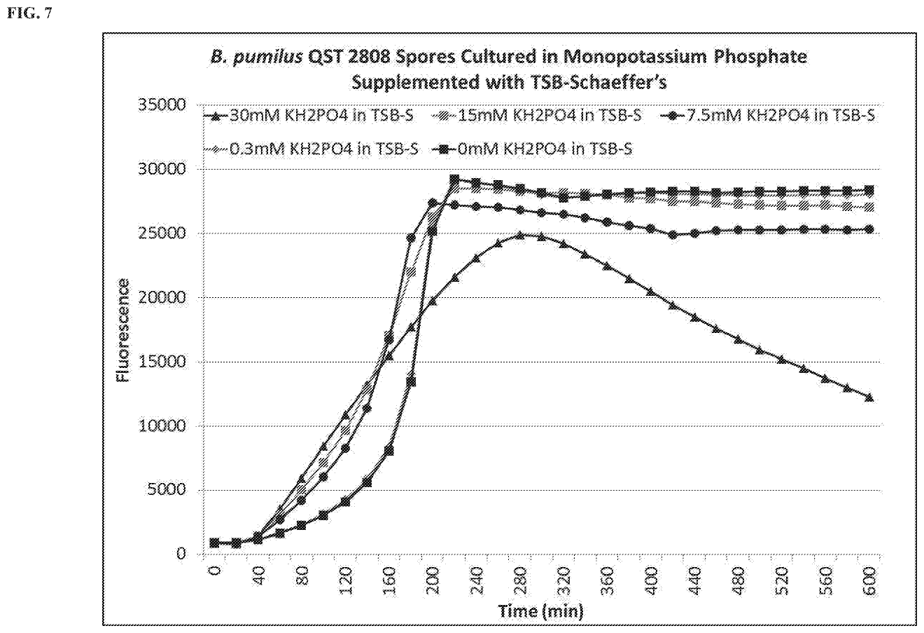

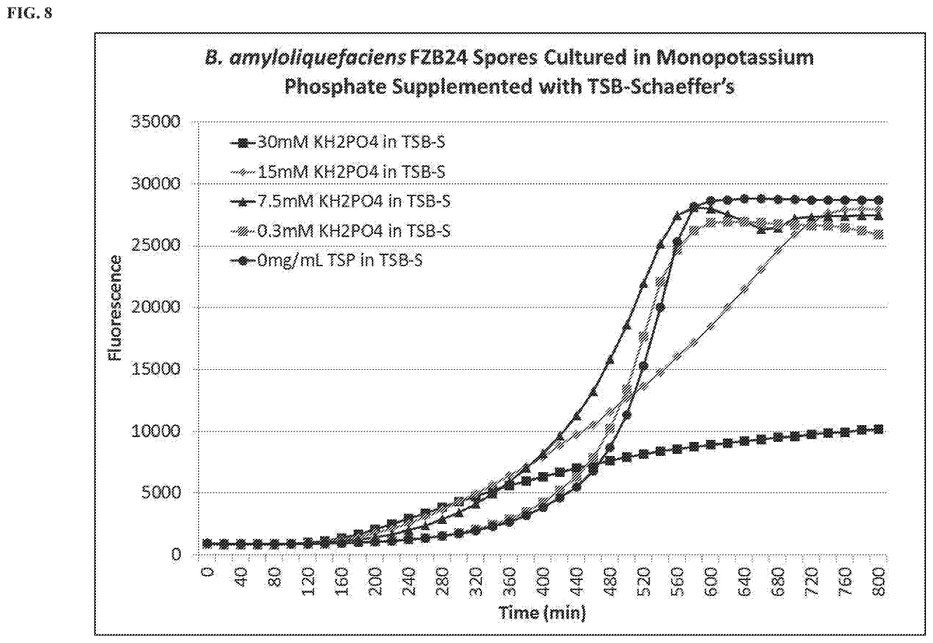

In each of the Bacillus strains tested, monopotassium phosphate stimulated early spore germination and growth (see FIGS. 5-8). A dose response was also observed across each of the strains with higher concentrations of monopotassium phosphate generally resulting in earlier bacterial spore germination and growth. These results demonstrate that the effect of monopotassium phosphate on bacterial spore germination and growth is not limited to Bacillus subtilis QST713 but is consistent across various Bacillus strains and genera including B. subtilis, B. amyloliquefaciens, and B. pumilus.

### Example 5

### Evaluation of the Effect of Triple Super Phosphate on Germination and Growth of Bacillus subtilis QST713 Bacterial Spores

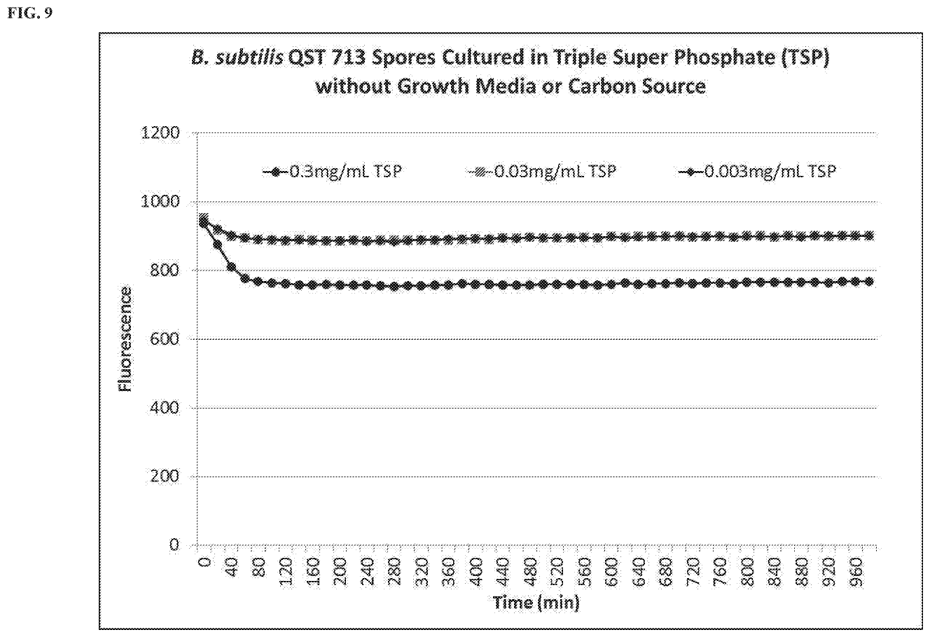

Another source of inorganic phosphate was evaluated for its effect on bacterial spore germination and growth. Triple Super Phosphate (TSP) contains a mixture of calcium phosphate, monobasic (Ca(H₂PO₄)₂) and calcium phosphate, dibasic (CaHPO₄). Purified Bacillus subtilis QST713 bacterial spores were cultured in minimal media containing concentrations of TSP of 0.003 mg/mL, 0.03 mg/mL, or 0.3 mg/mL. The metabolic activity of germinating and actively growing bacterial spores was monitored with the PRESTOBLUE® cell viability reagent (Invitrogen, Carlsbad, Calif.). In the absence of growth nutrient media (i.e., without a carbon source) the TSP did not stimulate the germination or growth of the Bacillus subtilis QST713 spores (see FIG. 9).

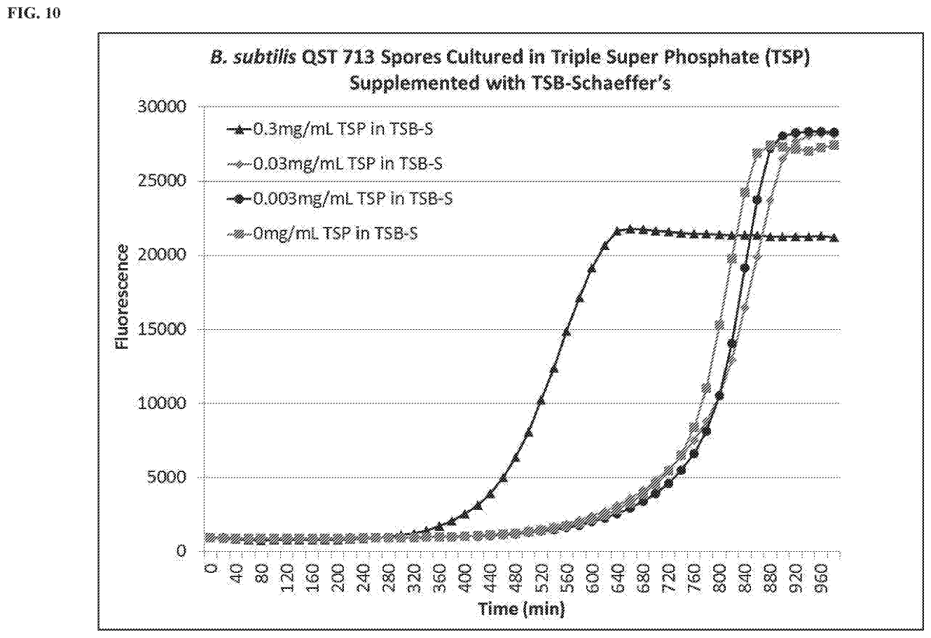

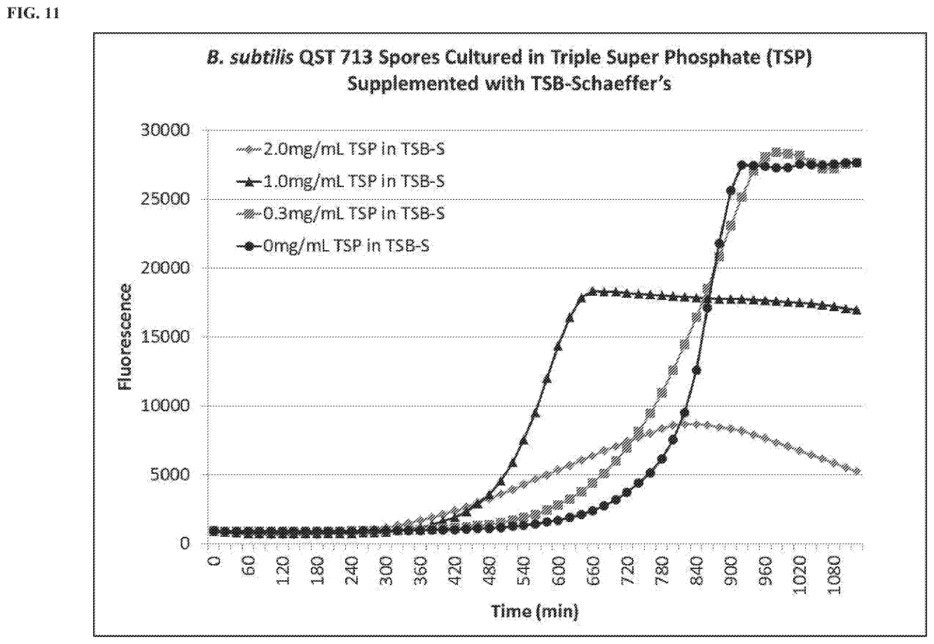

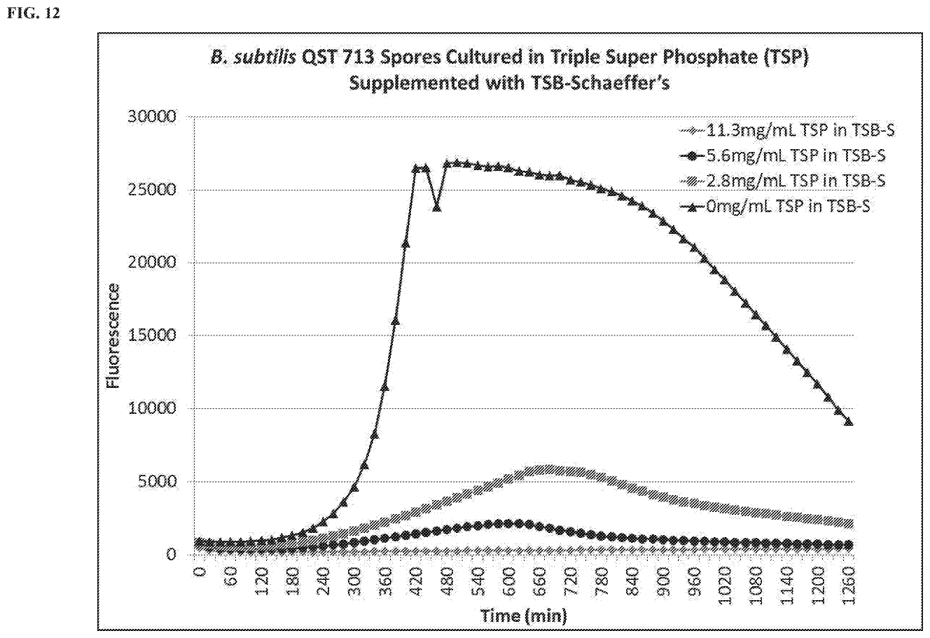

The purified spores of Bacillus subtilis QST713 were then cultured in TSB-S containing concentrations of TSP of 0.003 mg/mL, 0.03 mg/mL, or 0.3 mg/mL and compared to a control with TSB-S containing no TSP. With the carbon source provided by the TSB-S, 0.3 mg/mL TSP stimulated earlier bacterial spore germination and growth compared to TSB-S alone (see FIG. 10). This experiment was repeated with TSB-S containing concentrations of TSP of 0.3 mg/mL, 1.0 mg/mL, and 2.0 mg/mL, and at each of the concentrations of TSP the purified spores of Bacillus subtilis QST713 germinated and grew earlier than when the spores were cultured in TSB-S without TSP (see FIG. 11). In another experiment with TSB-S containing concentrations of TSP of 2.8 mg/mL or higher, the purified spores of Bacillus subtilis QST713 did not germinate or grow more quickly than the control spores cultured in TSB-S without TSP (see FIG. 12).

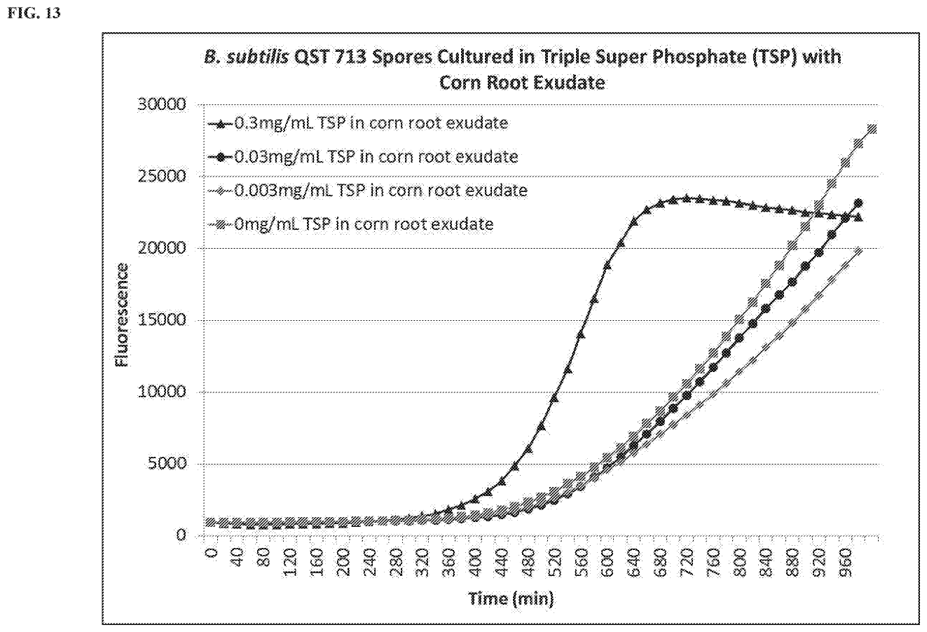

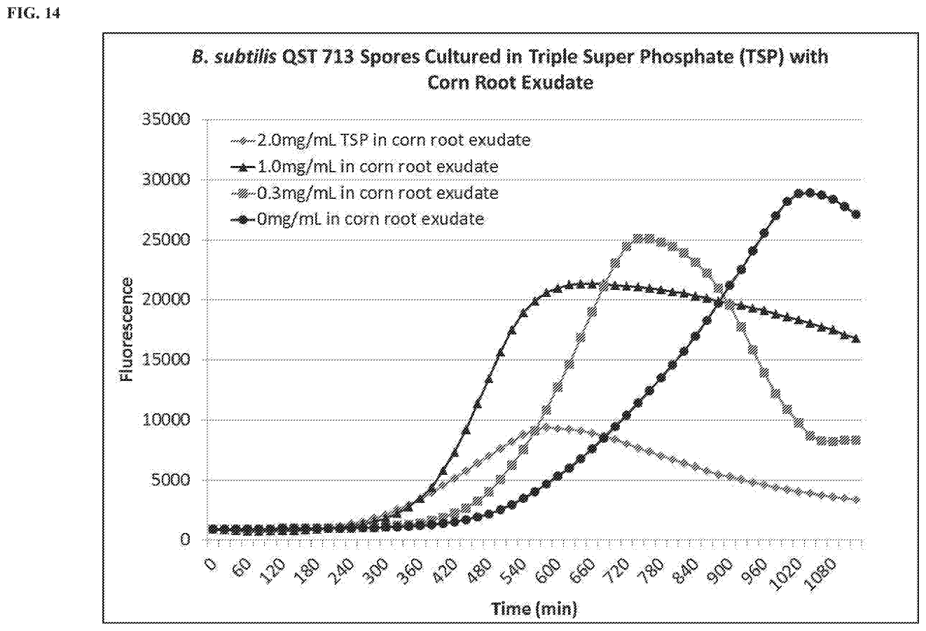

To mimic the environment that the bacterial spores experience in planta exudate was collected from corn roots and used in place of the TSB-S. Consistent with the observations with TSB-S supplemented with TSP, Bacillus subtilis QST713 spores cultured in corn root exudate with TSP experienced earlier germination and growth with the effect most pronounced at concentrations of TSP ranging from 0.3 mg/mL to 2.0 mg/mL (see FIGS. 13 and 14).

### Example 6

### Evaluation of the Effect of Triple Super Phosphate on Germination and Growth of Bacterial Spores from Other Bacillus Strains

To determine if the effect of TSP on bacterial spore germination and growth could be observed with other Bacillus strains, spores of Bacillus subtilis MBI 600, Bacillus subtilis GB03, Bacillus pumilus QST2808, and Bacillus amyloliquefaciens FZB24 were purified. Each type of purified bacterial spores was cultured in TSB-S alone or TSB-S supplemented with 0.3 mg/mL, 1.0 mg/mL, or 2.0 mg/mL TSP. The PRESTOBLUE® cell viability reagent was again used as a quantitative measure of metabolically active cells.

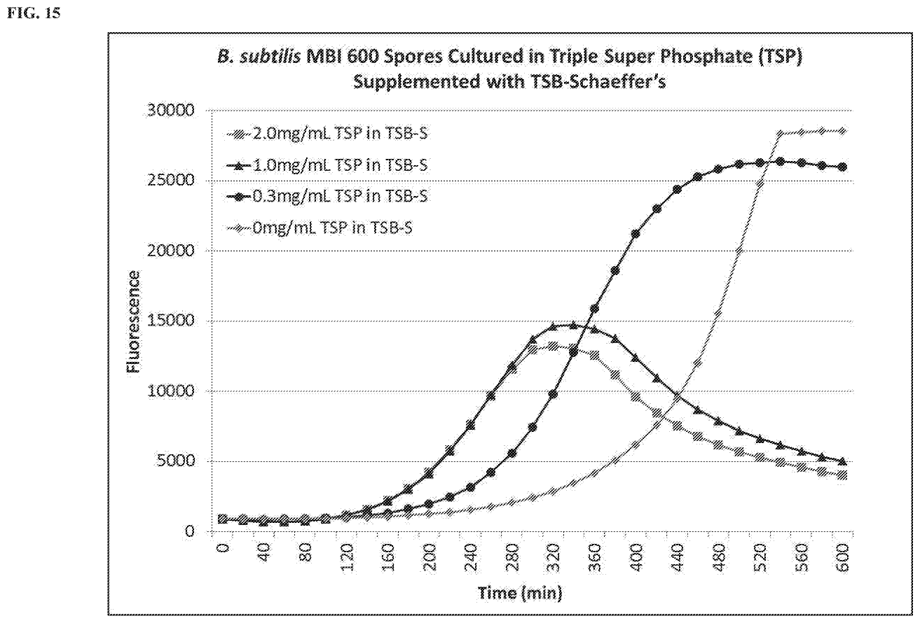

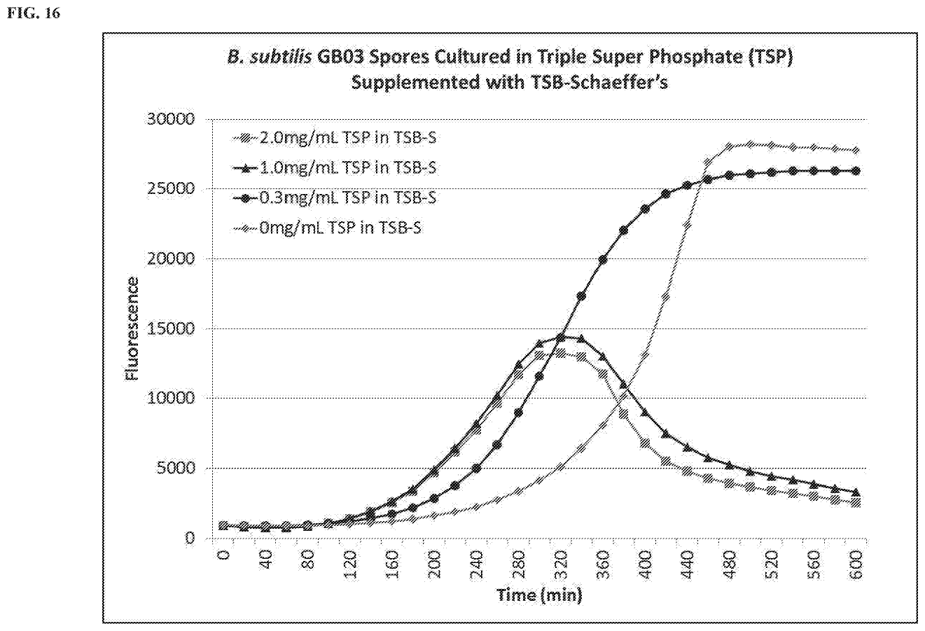

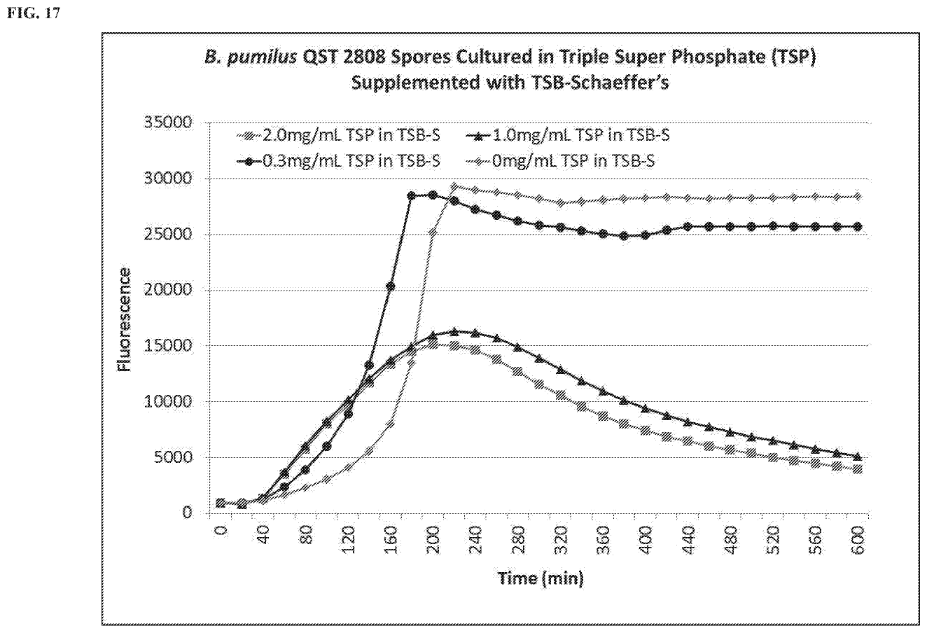

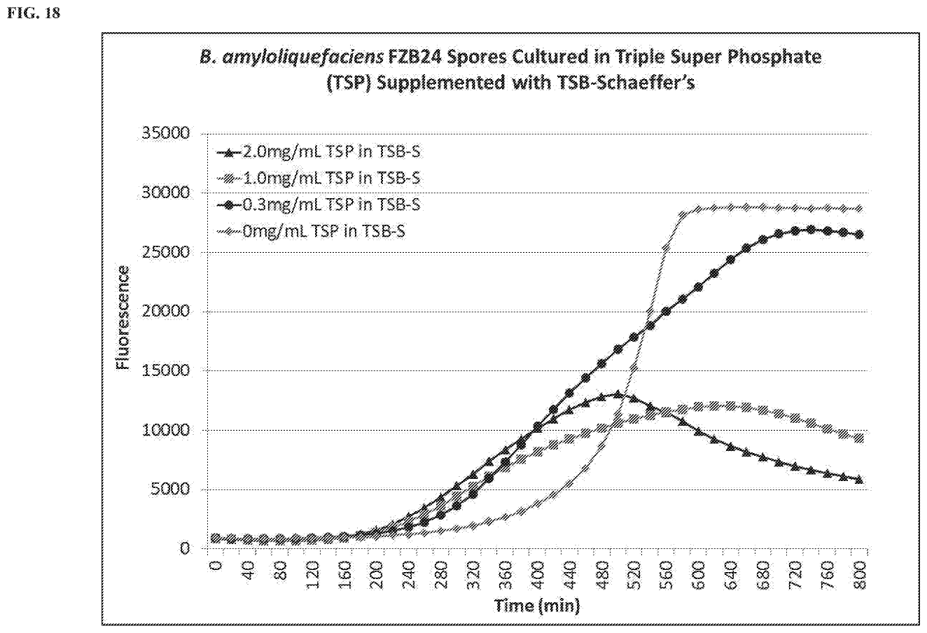

In each of the Bacillus strains tested, TSP stimulated early spore germination and growth (see FIGS. 15-18). As with the Bacillus subtilis QST713 spores, the effect was observed across TSP concentrations ranging from 0.3 mg/mL to 2.0 mg/mL. These results demonstrate that the effect of TSP on bacterial spore germination and growth is not limited to Bacillus subtilis QST713 but is consistent across various Bacillus strains and genera including B. subtilis, B. amyloliquefaciens, and B. pumilus.

### Example 7

### Evaluation of the Effect of Ammonium Polyphosphate on Germination and Growth of Bacillus subtilis QST713 Bacterial Spores

A third source of inorganic phosphate was evaluated for its effect on bacterial spore germination and growth. 10-34-0 Liquid Ammonium Polyphosphate (10-34-0) contains 10% nitrogen and 34% P₂O₅. Purified Bacillus subtilis QST713 bacterial spores were cultured in TSB-S containing dilutions of 10-34-0 of 1:2, 1:4, 1:8, or 1:16. Control samples contained Bacillus subtilis QST713 bacterial spores cultured in TSB-S without 10-34-0 or in a 1:16 dilution of 10-34-0 without TSB-S. The metabolic activity of germinating and actively growing bacterial spores was monitored with the PRESTOBLUE® cell viability reagent (Invitrogen, Carlsbad, Calif.).

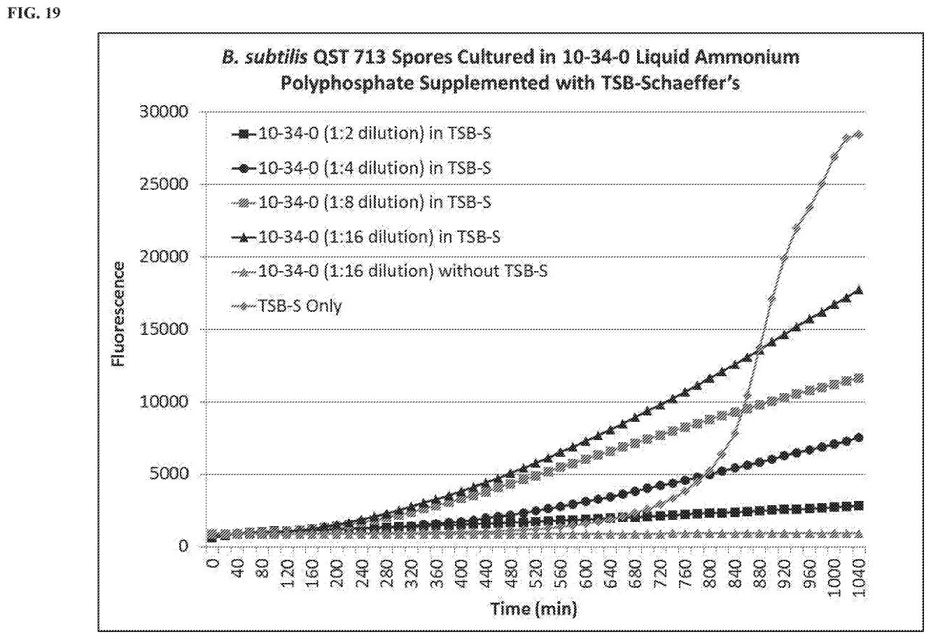

The 1:16 dilution of 10-34-0 without TSB-S induced no metabolic activity in the Bacillus subtilis QST713 bacterial spores. The most robust effect on early spore germination and growth was observed with Bacillus subtilis QST713 bacterial spores cultured in the 1:16 dilution of 10-34-0 in TSB-S with more concentrated solutions of 10-34-0 having less of an effect (see FIG. 19). These results confirm that inorganic phosphate from a variety of sources consistently induces early spore germination and growth with Bacillus bacterial spores compared to spores grown in the absence of inorganic phosphate.

Unless defined otherwise, all technical and scientific terms herein have the same meaning as commonly understood by one of ordinary skill in the art to which this invention belongs. All publications, patents, and patent publications cited are incorporated by reference herein in their entirety for all purposes.

Those skilled in the art will recognize, or be able to ascertain using no more than routine experimentation, many equivalents to the specific embodiments of the invention described herein. Such equivalents are intended to be encompassed by the following claims.

1-40. (canceled)

41. A composition comprising
(i) Bacillus spores of a plant growth-promoting Bacillus isolate, and
(ii) 0.004% to 0.5% (w/w) inorganic phosphate, in the absence of a carbon source.

42. The composition of claim 41, wherein the Bacillus isolate is Bacillus subtilis, Bacillus amyloliquefaciens, Bacillus pumilus, or a combination thereof.

43. The composition of claim 42, wherein the plant growth-promoting Bacillus isolate is selected from the group consisting of Bacillus subtilis var. amyloliquefaciens strain FZB24, Bacillus amyloliquefaciens strain FZB42, Bacillus amyloliquefaciens strain D747, Bacillus subtilis strain Y1336, Bacillus subtilis strain MBI 600, Bacillus subtilis strain QST713 (Accession No. NRRL B-21661), Bacillus subtilis AQ30002 (Accession No. NRRL B-50421), Bacillus subtilis AQ30004 (Accession No. NRRL B-50455), Bacillus pumilus QST2808 (Accession No. NRRL B-30087), mutants thereof with all the identifying characteristics of the respective strain, and combinations thereof.

44. The composition of claim 43, wherein the plant-growth promoting Bacillus isolate is Bacillus subtilis QST713 (Accession No. NRRL B-21661).

45. The composition of claim 41, wherein the inorganic phosphate is selected from the group consisting of phosphoric acid, polyphosphoric acid, phosphorous acid and a salt of H₂PO₄₋, H₂PO₃₋, HPO₄²⁻ or PO₄³⁻.

46. The composition of claim 41, wherein the inorganic phosphate is monopotassium phosphate.

47. The composition of claim 41, wherein the inorganic phosphate is calcium phosphate, monobasic (Ca(H₂PO₄)₂), calcium phosphate, dibasic (CaHPO₄), or a combination thereof.

48. The composition of claim 41 comprising 0.004% to 0.4% (w/w) monopotassium phosphate.

49. The composition of claim 41 comprising 0.3% to 0.28% (w/w) calcium phosphate, monobasic (Ca(H₂PO₄)₂), calcium phosphate, dibasic (CaHPO₄), or a combination thereof.

50. The composition of claim 41, wherein the plant-growth promoting Bacillus isolate is Bacillus subtilis QST713 (Accession No. NRRL B-21661) and the inorganic phosphate is monopotassium phosphate.
